(19) United States
(12) Patent Application Publication
(10) Pub. No.: US 2025/0373472 A1
(43) Pub. Date: Dec. 4, 2025

(54) CHANNEL AGING MITIGATION TECHNIQUES FOR TX EQUALIZED TRANSMISSIONS

(71) Applicant: QUALCOMM Incorporated, San Diego, CA (US)

(72) Inventors: Daniel PAZ, Atlit (IL); Michael LEVITSKY, Rehovot (IL); Tom BARAK, Rehovot (IL)

(21) Appl. No.: 18/732,508

(22) Filed: Jun. 3, 2024

(51) Int. Cl. H04L 25/03; H04L 5/00

(52) U.S. Cl. CPC H04L 25/03012; H04L 5/0051; H04L 2025/03783

(57) ABSTRACT

An apparatus may be a wireless device such as a user equipment (UE) configured to receive, from a wireless device associated with the UE, a first indication of a capability to perform an equalization operation and transmit, to the wireless device, a second indication of an allocation of resources associated with a pre-equalized demodulation reference signal (DMRS) for the equalization operation, wherein the allocation of resources is for less than all slots within a set of slots associated with a same pre-equalization.

### TECHNICAL FIELD

The present disclosure relates generally to communication systems, and more particularly, to a wireless communication associated with a pre-equalized transmission.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a wireless device such as a user equipment (UE) configured to receive, from a wireless device associated with the UE, a first indication of a capability to perform an equalization operation and transmit, to the wireless device, a second indication of an allocation of resources associated with a pre-equalized demodulation reference signal (DMRS) for the equalization operation, wherein the allocation of resources is for less than all slots within a set of slots associated with a same pre-equalization. For example, the allocated resources may be included in a number of slots that is less than a number of slots in a set of slots associated with a same pre-equalization.

In an aspect of the disclosure, a method, a computer-readable medium, and an apparatus are provided. The apparatus may be a wireless device (e.g., a user equipment (UE), an XR device, a VR device and/or headset, a portable monitor or wireless display, high definition multi-channel wireless audio, such as a wireless surround system for home cinema or true HD ear buds, etc.) configured to transmit, for a UE associated with the wireless device, a first indication of a capability to perform an equalization operation and receive, from the UE, a second indication of an allocation of resources associated with a pre-equalized DMRS for the equalization operation, wherein the allocation of resources is for less than all slots within a set of slots associated with a same pre-equalization.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an extended reality (XR) architecture and/or environment including an XR server hosted in a cloud, a base station providing access to the cloud, a UE (e.g., a companion device and/or a tethered device), and an XR device implementing an additional and/or alternative XR split architecture in accordance with some aspects of the disclosure.

FIG. 5 is a diagram illustrating an XR split between a UE and a XR device in accordance with some aspects of the disclosure.

FIG. 6A is a diagram illustrating a processing block diagram of a pre-equalization scheme for an OFDM waveform for a first pre-equalization method in accordance with some aspects of the disclosure.

FIG. 6B is a diagram illustrating a processing block diagram of a pre-equalization scheme for an OFDM waveform for a second pre-equalization method in accordance with some aspects of the disclosure.

FIG. 7 is a set of diagrams illustrating different equalization methods in accordance with some aspects, of the disclosure.

FIG. 8 is a call flow diagram illustrating a method of wireless communication in accordance with some aspects of the disclosure.

FIG. 9 is a flowchart of a method of wireless communication.

FIG. 10 is a flowchart of a method of wireless communication.

FIG. 11 is a flowchart of a method of wireless communication.

FIG. 12 is a flowchart of a method of wireless communication.

FIG. 13 is a flowchart of a method of wireless communication.

FIG. 14 is a diagram illustrating an example of a hardware implementation for an example apparatus and/or network entity.

### DETAILED DESCRIPTION

In some aspects of wireless communication, such as virtual reality (VR), augmented reality (AR), and/or extended reality (XR), balancing battery weight and battery life of a wireless device (e.g., smart phones, smart watches, wireless earbuds, glasses/goggles) providing a VR, SR, and/or XR application and/or experience may be associated with significant challenges. For example, the battery may be expected to be under a target weight and last for at least a target duration of continuous use. The battery life for a particular battery weight and/or size, in some aspects, may be extended by minimizing and/or limiting power consumption. In some aspects, minimizing power consumption may be based, at least in part, on limiting processing complexity at the wireless device. In some aspects, limiting and/or minimizing power consumption may also be associated with keeping heat production below a maximum heat dissipation rate (while maintaining a safe temperature).

While minimizing and/or limiting the processing complexity may extend a battery life, in some aspects, the XR application (used here and below to represent any of a VR/SR/XR application) may be associated with extensive processing and/or a high processing complexity. Accordingly, a standalone XR device (e.g., a wireless device providing an XR application and/or experience), in some aspects, may fail to simultaneously meet goals associated with battery weight and battery life based on the amount of processing associated with the XR application. Accordingly, in some aspects, a portion of the XR related processing may be shifted to a companion device with a split XR approach to reduce complexity on an XR device.

In some aspects, complexity at the XR device may be reduced by offloading some of the processing to related devices such as an XR server and/or a companion UE assisting the XR device in providing the XR service (e.g., by providing a communication link from the XR device to the XR server and vice versa). In some aspects in which the companion UE relays XR data between the XR device and the XR server the complexity reduction may include shifting (e.g., by eliminating/removing) a receiver complexity associated with Rx equalization (one of the key complexity contributors of wireless modem) and related procedures (e.g., channel estimation) from the XR device Rx side to the companion device (e.g., the Tx side). In some aspects, the Rx equalization complexity shifting may be applied for both OFDM and DFT-s-OFDM waveforms (for the latter case also FFT and IDFT related complexity can be eliminated). This complexity reduction on the XR device Rx side, in some aspects, may be achieved by applying a Tx pre-equalizer (or pre-equalization) on the companion device side instead of Rx equalization on the XR device side such that the equalization complexity is shifted from the receiver to the transmitter.

Applying a Tx pre-equalization scheme on the UE side allows a significant complexity reduction on the XR device side (at an Rx modem) while the performance may be approximately equivalent to a regular Rx side equalization. In some scenarios, Tx pre-equalization even allows some performance improvement. However, by applying a Tx pre-equalization scheme, certain DL slots may suffer from channel aging.

The transmissions to the XR device from the UE (DL direction) in some aspects, may be associated with a time division duplexed (TDD) scheme where multiple DL slots include pre-equalized DL data transmitted in association with a jumbo structure where the same pre-equalization matrix is used for the pre-equalized DL data transmitted in the multiple DL slots. In association with the jumbo structure, a new pre-equalization matrix may be periodically derived (which may be referred to as a “pre-equalization refresh”) and the time between each refresh (e.g., a periodicity of the refresh) may be referred to as a “pre-equalization refresh period.” Between pre-equalization refreshes, the slots may not include DMRS (e.g., a pre-equalized DMRS) as the equalization based on the DMRS is not performed at the XR device. In some aspects, a non-equalized DL RS may be transmitted to support DL CSI update once over a number of slots for scenarios where there is no channel reciprocity assumption and DL RS samples may be compressed and reported/indicated by the XR device to the companion device/UE in UL for pre-equalization refresh evaluation on the UE side.

Performing a pre-equalization refresh once every N slots may result in a channel aging effect where the actual channel that a pre-equalized DL slot experiences is different from the channel that was captured and/or estimated based on a last CSI refresh for DL and on which the Tx pre-equalization matrix may be derived. The channel aging may also be associated with, or be due to, synchronization loops, secondary synchronization (SS) errors, frequency offset (FO) and/or timing drifts, and mobility/movement of the XR device (even if limited). Channel aging, in some aspects, will cause more significant performance degradation on DL slots including pre-equalized DL data that are allocated toward the end of the pre-equalization refresh period (e.g., a CSI refresh period and/or multi-slot jumbo allocation) than for DL slots including pre-equalized DL data near the beginning of the pre-equalization refresh period. For example, the DL slots including pre-equalized DL data that are allocated toward the end of the pre-equalization refresh period may experience a channel that has changed more from the channel experienced by the DL RS used to determine the pre-equalization than the DL slots including pre-equalized DL data near the beginning of the pre-equalization refresh period. This effect, in some aspects, may impose a limit on the length of the pre-equalization refresh period that can be used and the reduced period may increase the overhead of DL RS reporting (e.g., in the case of no channel reciprocity).

Various aspects relate generally to mitigating the channel aging effect. Some aspects more specifically relate to allocating a pre-equalized DMRS for a subset (e.g., less than all) of the slots within a multi-slot and/or jumbo allocation that will allow the XR device to fallback to Rx side equalization if a low complexity reception attempt (e.g., a decoding without Rx side equalization) fails. In some examples, a wireless device (e.g., a UE) may be configured to receive, from a wireless device associated with the UE, a first indication of a capability to perform an equalization operation and transmit, to the wireless device, a second indication of an allocation of resources associated with a pre-equalized DMRS for the equalization operation, wherein the allocation of resources is for less than all slots within a set of slots associated with a same pre-equalization. In some aspects a wireless device (e.g., an XR device) may be configured to transmit, for a UE associated with the wireless device, a first indication of a capability to perform an equalization operation and receive, from the UE, a second indication of an allocation of resources associated with a pre-equalized DMRS for the equalization operation, wherein the allocation of resources is for less than all slots within a set of slots associated with a same pre-equalization.

Particular aspects of the subject matter described in this disclosure can be implemented to realize one or more of the following potential advantages. In some examples, by allocating the pre-equalized DMRS for the subset of the slots within the multi-slot and/or jumbo allocation, the described techniques can be used to increase the robustness of Tx equalization and reduce a decoding failure rate (and a related number of retransmission events). The reduced decoding failure may lead to an improved link efficiency (associated with a reduced retransmission overhead) and a reduced DL latency. In some aspects, by reducing the probability of DL latency at a tail of the distribution (e.g., the longest DL latencies) may lead to a significant improvement for highly latency sensitive applications. For example, an XR experience may be greatly improved by reducing the long tail of the DL latency distribution.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

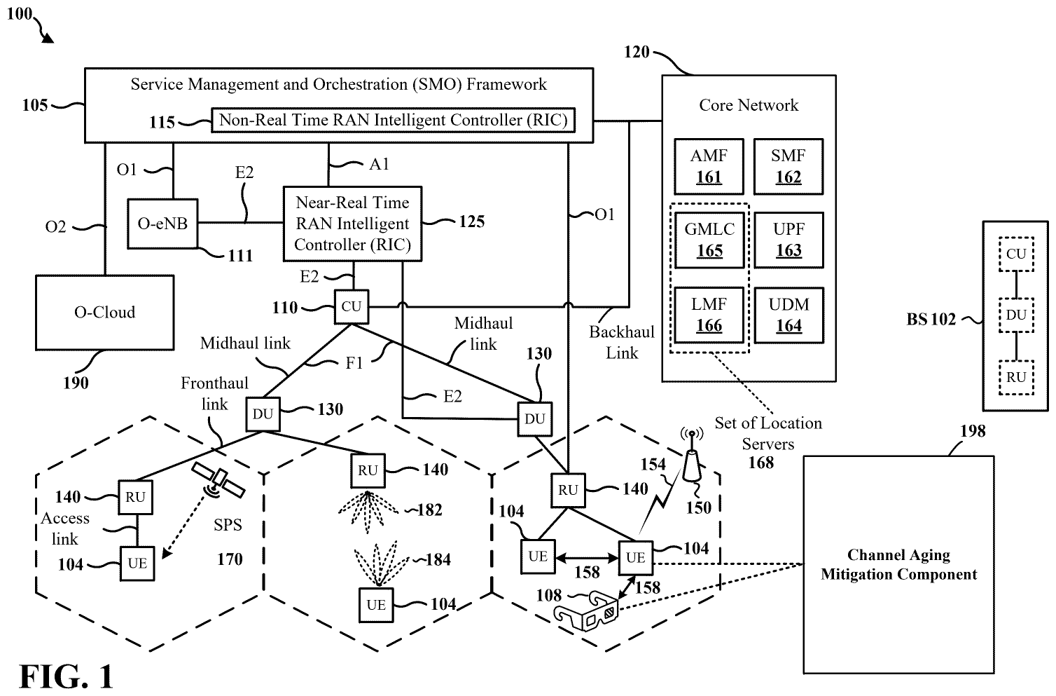

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 and/or an XR device 108 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a channel aging mitigation component 198 that may be configured to receive, from a wireless device associated with the UE, a first indication of a capability to perform an equalization operation and transmit, to the wireless device, a second indication of an allocation of resources associated with a pre-equalized DMRS for the equalization operation, wherein the allocation of resources is for less than all slots within a set of slots associated with a same pre-equalization. In certain aspects, the XR device 108 may have a channel aging mitigation component 198 that may be configured to transmit, for a UE associated with the wireless device, a first indication of a capability to perform an equalization operation and receive, from the UE, a second indication of an allocation of resources associated with a pre-equalized DMRS for the equalization operation, wherein the allocation of resources is for less than all slots within a set of slots associated with a same pre-equalization. Although the following description may be focused on an XR device and a companion UE, in some aspects, the same methods may be applicable for any pair of similarly-configured wireless devices (e.g., a reduced capability (RedCap) UE and a companion UE and/or base station) implementing a Tx equalization and/or pre-equalization for communications in at least a first direction.

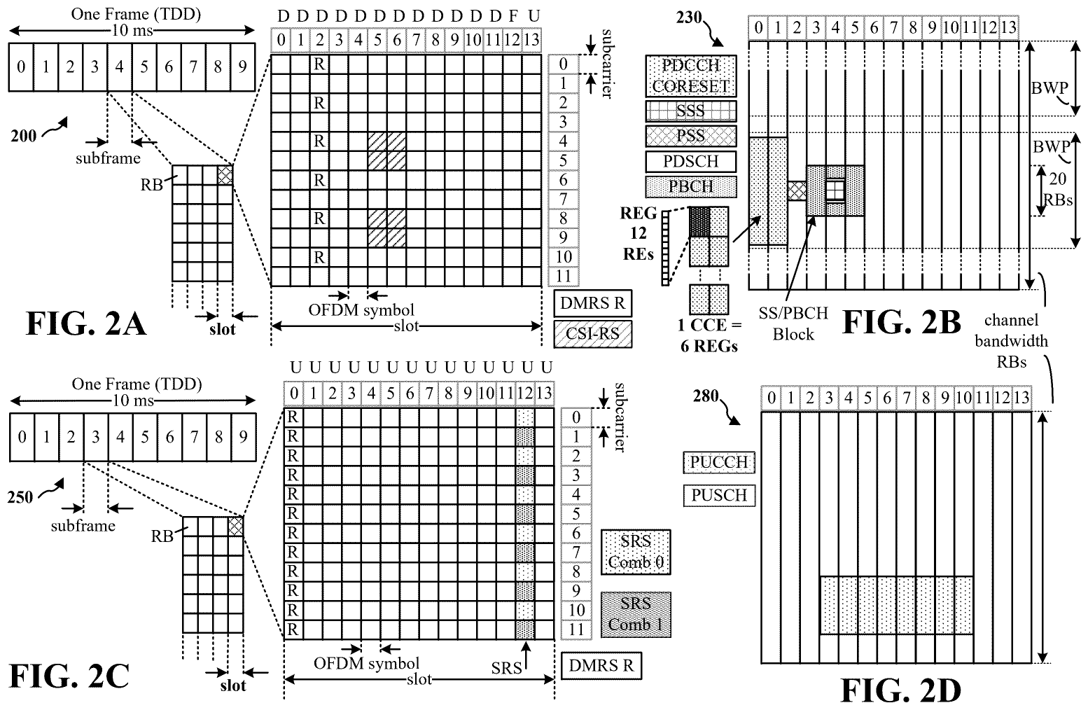

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 24*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

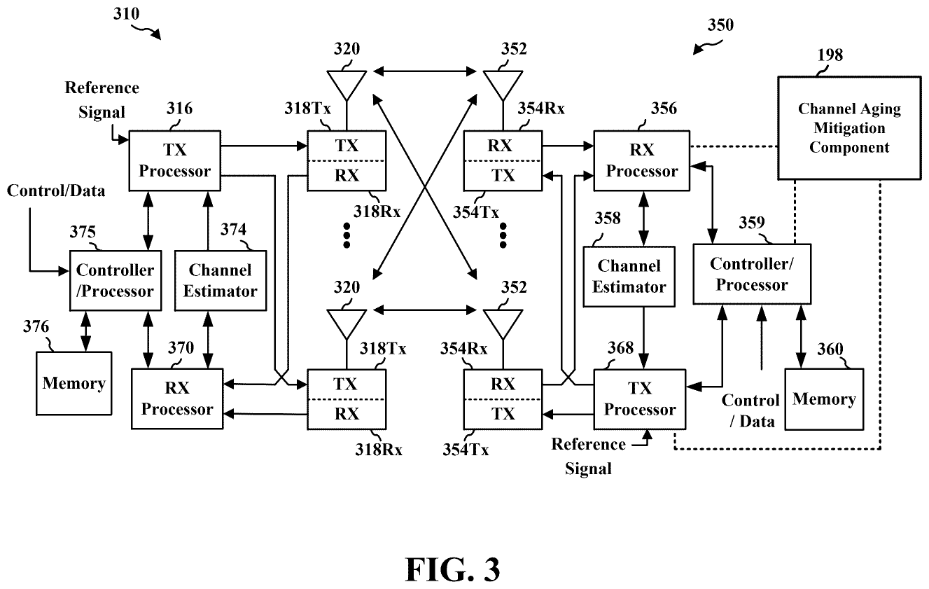

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antennas 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the channel aging mitigation component 198 of FIG. 1.

In some aspects of wireless communication, such as VR, AR, and/or XR, balancing battery weight and battery life of a wireless device (e.g., smart phones, smart watches, wireless earbuds, glasses/goggles) providing a VR, SR, and/or XR application and/or experience may be associated with significant challenges. For example, the battery may be expected to be under a target weight and last for at least a target duration of continuous use. The battery life for a particular battery weight and/or size, in some aspects, may be extended by minimizing and/or limiting power consumption. In some aspects, minimizing power consumption may be based, at least in part, on limiting processing complexity at the wireless device. In some aspects, limiting and/or minimizing power consumption may also be associated with keeping heat production below a maximum heat dissipation rate (while maintaining a safe temperature).

While minimizing and/or limiting the processing complexity may extend a battery life, in some aspects, the XR application (used here and below to represent any of a VR/SR/XR application) may be associated with extensive processing and/or a high processing complexity. Accordingly, a standalone XR device (e.g., a wireless device providing an XR application and/or experience), in some aspects, may fail to simultaneously meet goals associated with battery weight and battery life based on the amount of processing associated with the XR application. Accordingly, in some aspects, a portion of the XR related processing may be shifted to a companion device with a split XR approach to reduce complexity on an XR device.

A split XR approach, in some aspects, may move most of the rendering-related processing to a companion device but may leave some processing components on the XR device for different end-to-end (E2E) considerations (e.g., a motion-to-photon latency specification, an XR device to companion device wireless link capacity, a communication link power consumption for long range links, etc.). Even though this split XR option significantly reduces power consumption on an XR device, the power consumption may still be too high such that the issues associated with the battery life and battery weight/size may not be completely solved and may not support more demanding XR applications (e.g., an XR application associated with a frame rate greater than 120 frames per second (fps) and a high-quality video format such as 8K) or even a less demanding application associated with less demanding video quality/user experience benchmarks.

A split option between an XR server (e.g., a server providing VR/AR/XR data for a VR/AR/XR application) and an XR device, in some aspects, assumes long range communication links over licensed spectrum with a tight scheduling and staggering among different served XR users. In some aspects, capacity per user may be the primary limitation, and correspondingly, the XR device may employ some sensor processing (e.g., 6 degrees of freedom (6DOF) tracking, eye tracking for field of vision (FOV) derivation, etc.) locally to reduce UL data volume while additional sensor and/or camera data from the XR device transmitted to the XR server (e.g., UL data) and the rendered video for the XR device transmitted to the XR device (e.g., DL data) may be compressed with a very high compression factor (due to a limited link capacity per user).

Sensor data pre-processing on XR device and video compression with sufficiently high compression factor (e.g., “High profile”), in some aspects, may have a very high complexity (especially for the encoder side) and may be associated with extensive DDR usage for both Tx/Rx path video processing (DDR is a heavy power consumer by itself). Due to motion-to-photon latency specifications and gNB based split related latencies, Rx side processing on XR device includes also asynchronous time wrapping (ATW) for last moment image alignment with the latest pose information. Accordingly, a power consumption, even in the XR split architecture may be too high to meet desired thresholds for maximum battery size/weight and minimum threshold for battery life.

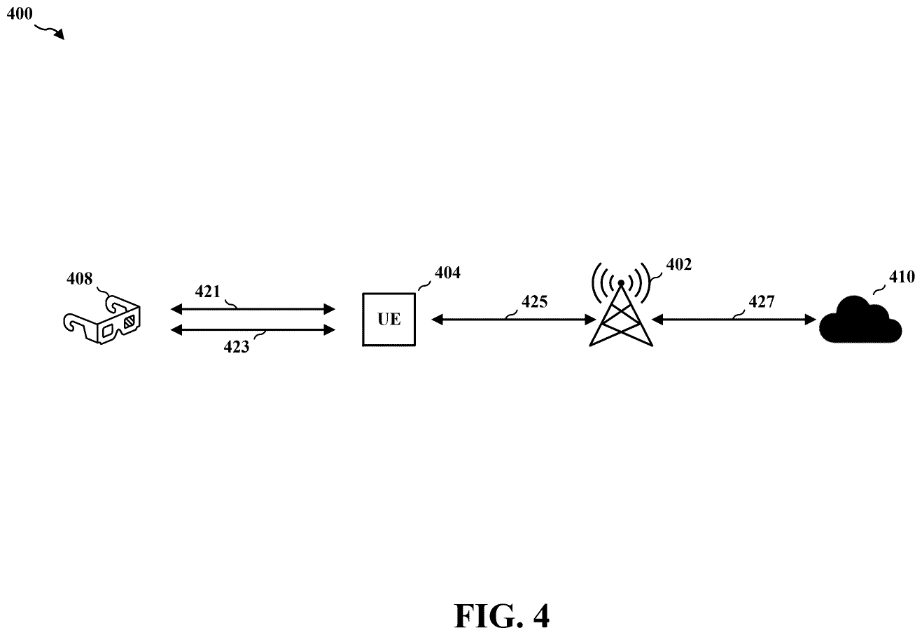

The XR split architecture discussed above assumes that the XR server and/or the XR device provide the processing. FIG. 4 is a diagram 400 illustrating an XR architecture and/or environment including an XR server hosted in a cloud 410, a base station 402 providing access to the cloud 410, a UE 404 (e.g., a companion device and/or a tethered device), and an XR device 408 implementing an additional and/or alternative XR split architecture in accordance with some aspects of the disclosure. Diagram 400 illustrates that a first communication link 427 may exist between the cloud 410 (e.g., the XR server hosted on the cloud 410) and a second communication link 425 between the base station 402 and the UE 404. Between the UE 404 and the XR device 408 (e.g., VR/AR/XR glasses or a head mounted display) there may be a plurality of links based on different technologies such as a first local communication link 421 based on a 5G communication link (e.g., SL) and a second local communication link 423 associated with Wi-Fi or some other technology or standard. In the environment illustrated in diagram 400, at least one alternative XR split architecture may include offloading processing from the XR device 408 to the UE 404 (e.g., a relatively close companion device to the XR device). Accordingly, the processing may be split among the XR server, the companion device, and the XR device.

In some aspects, the alternative XR split may be associated with a similar processing load and locally covered functionality for the XR device but may reduce a power consumption associated with UL transmission by using a local short range communication link with the associated UE (e.g., over a 5G NR SL or Wi-Fi) and having the associated UE communicate with the XR server over a radio network in a licensed spectrum. An alternative approach for dividing the processing among the XR server, the companion device, and the XR device, may involve an aggressive processing offloading from the XR device to its companion device (e.g., a UE or to the UE and an associated base station). For example, to the extent possible, the Tx and Rx complexity associated with the XR application (and formerly associated with processing at the XR device) may be shifted/moved to the UE/companion device side. This complexity shifting, in some aspects, may extend across all the functional components of XR device including PHY/modem related complexity. Accordingly, in this alternative approach, the XR device may be considered an I/O device that shares all the local sensor information with the companion device without pre-processing and receives from the UE rendered video to be displayed directly without post-processing.

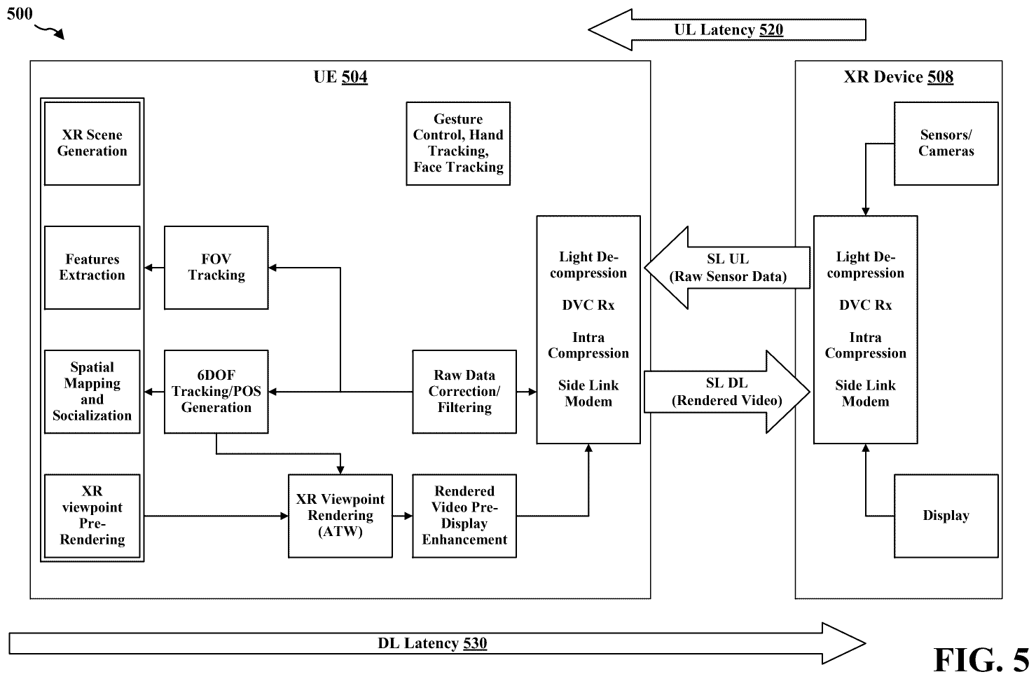

FIG. 5 is a diagram 500 illustrating an XR split between a UE 504 and a XR device 508 in accordance with some aspects of the disclosure. For example, in some aspects, the complexity reduction may include shifting (e.g., by eliminating/removing) the receiver complexity associated with Rx equalization (one of the key complexity contributors of wireless modem) and related procedures (e.g., channel estimation) from the XR device Rx side to the companion device (e.g., the Tx side). In some aspects, the Rx equalization complexity shifting may be applied for both OFDM and DFT-s-OFDM waveforms (for the latter case also FFT and IDFT related complexity can be eliminated). This complexity reduction on the XR device Rx side, in some aspects, may be achieved by applying a Tx pre-equalizer (or pre-equalization) on the companion device side instead of Rx equalization on the XR device side such that the equalization complexity is shifted from the receiver to the transmitter. FIG. 5 also depicts UL latency 520 and DL latency 530 between the UE 504 and the XR device 508.

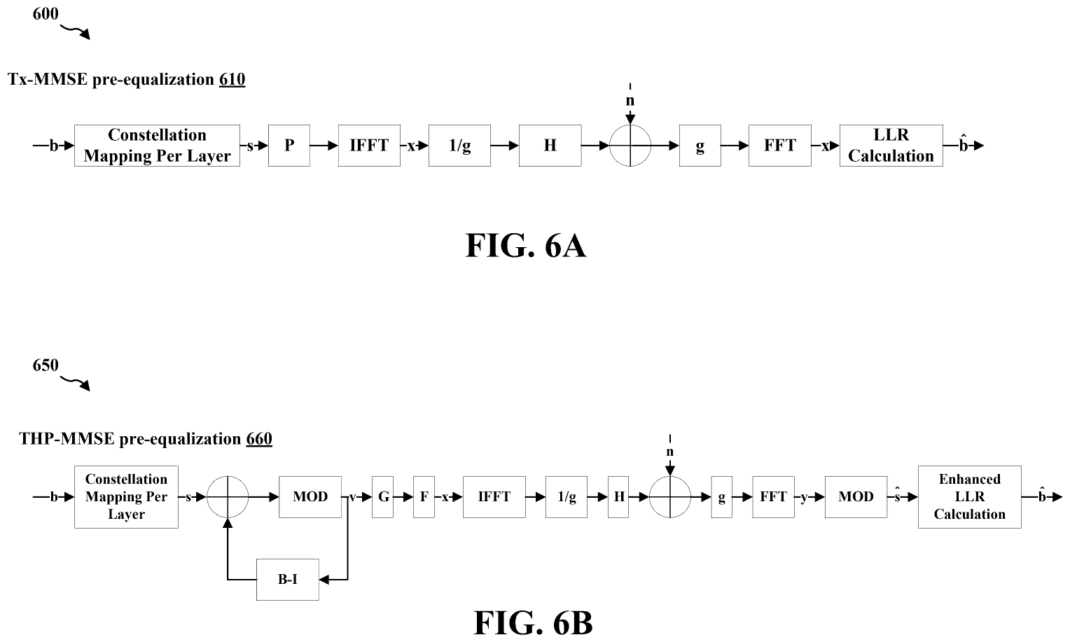

FIG. 6A is a diagram 600 illustrating a processing block diagram of a pre-equalization scheme 610 for an OFDM waveform for a first pre-equalization method in accordance with some aspects of the disclosure. In some aspects, the first pre-equalization method may be associated with a minimum mean square error (MMSE) pre-equalization. FIG. 6B is a diagram 650 illustrating a processing block diagram of a pre-equalization scheme 660 for an OFDM waveform for a second pre-equalization method in accordance with some aspects of the disclosure. In some aspects, the second pre-equalization method may be associated with a Tomlinson-Harashima precoding (THP) MMSE pre-equalization.

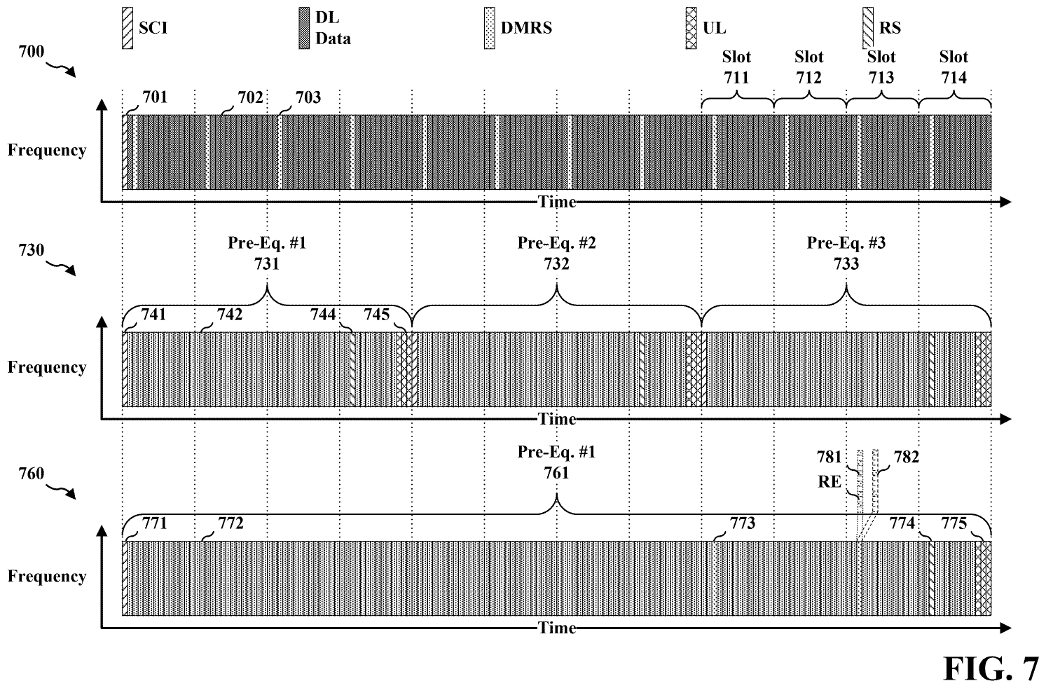

FIG. 7 is a set of diagrams (e.g., including diagram 700, diagram 730, and diagram 730) illustrating different equalization methods in accordance with some aspects, of the disclosure. Diagram 700 illustrates a slot structure including an allocation of DMRS in each of a plurality of slots for a Rx side equalization. The slot structure may further include SL control information 701 (SCI), DL data 702, and the DMRS 703. Diagram 730 illustrates a slot structure including different sets of slots (e.g., jumbo allocations), where each set of slots is associated with a same Tx pre-equalization (e.g., a first pre-equalization 731, a second pre-equalization 732, and a third pre-equalization 733) and no DMRS. The slot structure associated with pre-equalization may include SCI 741, pre-equalized DL data 742, a DL RS 744 (e.g., a RS that can be measured and reported to the UE to calculate the pre-equalization), and UL data 745 (e.g., for reporting the measurements of the DL RS 744). Applying a Tx pre-equalization scheme on the UE side allows a significant complexity reduction on the XR device side (at an Rx modem) while the performance may be approximately equivalent to a regular Rx side equalization. In some scenarios, Tx pre-equalization even allows some performance improvement (see Table 2) over RX side equalization. For example, Table 2 indicates a maximum MCS that is expected to be decodable based on a signal to noise ratio (SNR), a slot number since a channel estimation, and an equalization method (e.g., either THP-MMSE based pre-equalization or Rx side equalization). Table 2 further indicates that by applying a Tx pre-equalization scheme, certain DL slots may suffer from channel aging that gets worse over time (indicated by the reduction in the expected maximum decodable MCS). The number of slots in each set of slots (e.g., a jumbo allocation associated with a pre-equalization refresh period), in some aspects, may be selected to avoid the effects of channel aging (to maintain the expected maximum decodable MCS at a first slot). For example, the pre-equalization refresh period in diagram 730 may be 4 slots, e.g., based on an SNR of 12, 13, or 17 for which the expected maximum decodable MCS degrades after the fourth slot.

TABLE 2
Supported MCS by Slot, SNR, and Equalization Method

| Equalization | Slot | SNR | | | | | | | |
|---|---|---|---|---|---|---|---|---|---|
| Method | Index | 10 | 11 | 12 | 13 | 14 | 15 | 16 | 17 |
| THP-MMSE | 1 | 11 | 11 | 12 | 13 | 13 | 14 | 15 | 15 |
| THP-MMSE | 2 | 11 | 11 | 12 | 13 | 13 | 14 | 15 | 15 |
| THP-MMSE | 3 | 8 | 11 | 12 | 13 | 13 | 14 | 14 | 15 |
| THP-MMSE | 4 | 8 | 11 | 12 | 13 | 13 | 14 | 14 | 15 |
| THP-MMSE | 5 | 8 | 11 | 11 | 12 | 13 | 14 | 14 | 14 |
| THP-MMSE | 6 | 8 | 11 | 11 | 12 | 13 | 13 | 14 | 14 |
| THP-MMSE | 7 | 7 | 11 | 11 | 12 | 12 | 13 | 13 | 14 |
| THP-MMSE | 8 | 7 | 8 | 11 | 11 | 12 | 12 | 13 | 13 |
| THP-MMSE | 9 | 7 | 8 | 11 | 11 | 11 | 12 | 12 | 13 |
| THP-MMSE | 10 | 7 | 8 | 8 | 11 | 11 | 11 | 12 | 12 |
| THP-MMSE | 11 | 7 | 7 | 8 | 11 | 11 | 11 | 11 | 12 |
| THP-MMSE | 12 | 7 | 7 | 8 | 8 | 11 | 11 | 11 | 11 |
| RX MMSE | 1 | 7 | 8 | 10 | 11 | 12 | 12 | 13 | 13 |

As illustrated in diagram 730, the transmissions to the XR device from the UE (e.g., in the DL direction) in some aspects, may be associated with a TDD scheme where multiple DL slots include pre-equalized DL data (e.g., pre-equalized DL data 742) transmitted in association with a jumbo structure where the same pre-equalization matrix (e.g., one of the first pre-equalization 731, the second pre-equalization 732, or the third pre-equalization 733) is used for the pre-equalized DL data transmitted in the multiple DL slots. Between pre-equalization refreshes, the slots may not include DMRS (e.g., a pre-equalized DMRS) as the equalization based on the DMRS is not performed at the XR device. In some aspects, a non-equalized DL RS (e.g., DL RS 744) may be transmitted to support DL CSI update once over a number of slots for scenarios where there is no channel reciprocity assumption and DL RS samples may be compressed and reported/indicated by the XR device to the companion device/UE in UL (e.g., via UL data 745) for pre-equalization refresh evaluation on the UE side.

As illustrated in Table 2, performing a pre-equalization refresh once every N slots may result in a channel aging effect where the actual channel that a pre-equalized DL slot experiences is different from the channel that was captured and/or estimated based on a last CSI refresh for DL and on which the Tx pre-equalization matrix may be derived. The channel aging may also be associated with, or be due to, synchronization loops, SS errors, FO and/or timing drifts, and mobility/movement of the XR device (even if limited). Channel aging, in some aspects, will cause more significant performance degradation on DL slots including pre-equalized DL data that are allocated toward the end of the pre-equalization refresh period (e.g., a CSI refresh period and/or multi-slot jumbo allocation) than for DL slots including pre-equalized DL data near the beginning of the pre-equalization refresh period. For example, the later slots may be associated with a lower expected maximum decodable MCS as illustrated in Table 2. This effect, in some aspects, may impose a limit (e.g., 2-7 slots for the SNR values included in Table 2) on the length of the pre-equalization refresh period that can be used while maintaining a highest MCS and the reduced period may increase the overhead of SCI configuring the jumbo allocation and DL RS reporting (e.g., in the case of no channel reciprocity).

Various aspects relate generally to mitigating the channel aging effect. Some aspects more specifically relate to allocating a pre-equalized DMRS for a subset (e.g., less than all) of the slots within a multi-slot and/or jumbo allocation that will allow the XR device to fallback to Rx side equalization if a low complexity reception attempt (e.g., a decoding without Rx side equalization) fails. Diagram 760 illustrates an additional slot structure associated with such an allocation of a pre-equalized DMRS for a subset (e.g., less than all) of the slots within a multi-slot and/or jumbo allocation. Each slot in the jumbo allocation, in some aspects, may be associated with a first pre-equalization 761. The additional slot structure associated with the allocation of the pre-equalized DMRS may include SCI 771, pre-equalized DL data 772, a pre-equalized DMRS 773, a DL RS 774 (e.g., a RS that can be measured and reported to the UE to calculate the pre-equalization for the next jumbo allocation), and UL data 775 (e.g., for reporting the measurements of the DL RS 744). Each pre-equalized DMRS (e.g., pre-equalized DMRS 773) in the set of slots and/or jumbo allocation, in some aspects, may include transmissions in non-adjacent frequency resources (e.g., REs) as in a first pre-equalized DMRS configuration 781 or a second pre-equalized DMRS configuration 782. In some aspects, the slots within a multi-slot allocation and/or jumbo allocation may be associated with a slot index indicating a position within the jumbo allocation and/or a time elapsed since a last pre-equalization matrix calculation.

The additional slot structure illustrated in diagram 760, in some aspects, may be associated with a larger number of slots in a jumbo allocation (e.g., a larger pre-equalization refresh period of 12 slots vs. 4 slots) that may be associated with decreasing the overhead associated with the SCI and channel estimation resources associated with calculating the pre-equalization (e.g., the pre-equalization matrix) and may allow for an increased MCS (e.g., an increased data rate), which may offset additional overhead associated with transmitting the pre-equalized DMRS in a select set of slots within, and near the end of, the jumbo allocation. In some aspects, the number of slots including the pre-equalized DMRS may further be reduced by enabling and/or configuring the XR device to reuse a channel estimated based on a pre-equalized DMRS included in a nearest slot (e.g., the ninth slot 711 or the eleventh slot 713) within a lookback window to perform a Rx side equalization for a subsequent slot (e.g., the tenth slot 712 or the twelfth slot 714). The pre-equalized DMRS, in some aspects, may allow RX-side equalization in case of a CRC failure with the proposed low complexity XR receiver processing. In some aspects, the slot structures illustrated in each of diagrams 700, 730, and 760 may further include additional data (e.g., log likelihood ratio (LLR) data) scaling RS separately from the DMRS 703, the DL RS 744, and the pre-equalized DMRS 773.

As discussed in relation to FIG. 7, an allocation of Tx pre-equalized DMRS (pre equalized with the same pre-equalization matrix as the data) to a part, but not all, of the DL slots within a multi-slot and/or jumbo allocation toward the end of the Tx equalization refresh period may be provided to allow a fallback to RX-side equalization in case of any CRC failure on the corresponding slots due to channel aging to avoid a potential increase in HARQ re-transmissions rate. In some aspects, DMRS is used to support an Rx side equalization associated with a channel estimation on the corresponding slot at the XR side to evaluate the equalizer. In the slot structure and/or DMRS allocation illustrated in diagram 760, typical XR RX processing including channel estimation may not be used as there is no RX side equalization (the reception relies purely on Tx equalization) and accordingly for the majority of the slots there is no need for a channel estimation pilot (e.g., a DMRS).

In some aspects, in order to support the proposed additional slot structure, the XR/Rx side should have the capability for RX side equalization and may report that capability to the UE at the initial connection phase. Within the capability report, in some aspects, the XR will indicate an upper bound on the number of RX side equalizations that can be performed within a certain time-period. This indication can be used by the XR manufacturer to limit the power consumption and heat dissipation specification on the XR modem side due to full Rx-side processing.

The UE, in some aspects, may configure (e.g., via RRC) the XR with a set of possible DMRS allocation/mapping options (e.g., inter slot TD and, optionally, FD grid) along with a CSI refresh period/multi-slot allocation in DL and along with possible TDD grids/patterns, based on the corresponding XR capabilities. Allocated DMRS, in some aspects. may be sparse in TD (e.g., once every 2 slots) and/or FD (e.g., once every 4 REs) assuming that some threshold level of equalization is still preserved. The UE, in some aspects, may dynamically indicate the pre-equalized DMRS allocation option (from the list of pre-defined options) per multi-slot/jumbo allocation via the DCI/SCI//control channel, where a new field may be introduced to support this proposal or an existing field may be re-purposed for this case when Tx equalized waveform is used).

The size of the jumbo allocation and the number and/or position of allocated DMRS symbols (or selection one of the pre-defined patterns) may be determined based on a retransmission rate, bit rate specifications, an available link capacity (where, in some aspects, it may be problematic to quickly decrease the used MCS index), and the measured latency characteristics (e.g., a probability distribution of a long latency tail). In some aspects, the dynamic determination may be additionally, or alternatively, based on channel time correlation measurements and/or channel mobility characteristics and even based on XR movement tracking (IMU readings or XR position tracking).

In some aspects, MAC-CE based configuration/reconfiguration for the DMRS allocation may be used. The MAC-CE based signaling option, may be used, e.g., for cases where per-packet reconfiguration is not needed but reconfiguration may be specified from time to time and in a low latency manner. In some aspects, the pre-equalized DMRS allocation option will be derived by the UE (or Tx side employing Tx equalization) considering different factors such as (1) the estimated channel time correlation evaluated based on UL DMRS where a channel reciprocity assumption holds or based on DL non equalized DMRS samples signaling from the Rx side to Tx side if channel reciprocity cannot be assumed; (2) a battery level indication from the XR device (e.g., the UE may determine to use a more robust MCS for the slot structure not including the DMRS such as the slot structure illustrated in diagram 730 of FIG. 7 instead of the slot structure including the pre-equalized DMRS such as the slot structure illustrated in diagram 760 of FIG. 7 due to increased power consumption of RX-side equalization), and/or (3) ACK/NACK statistics and/or an ACK/NACK rate from the XR/Rx (for DL), e.g., indicating a decoding failure rate.

To reduce latency (based on a first failed decoding trial without equalization before a successful decoding with equalization), for cases where a certain slot index is consistently failing CRC in the absence of Rx side equalization, the UE may configure Rx side equalization by default for the corresponding slot index. Based on the configuration (e.g., an indication of the slots associated with a default Rx side equalization) from the UE, the XR/Rx side will use Rx side equalization immediately without waiting for a CRC failure for the indicated slots when trying to process them without Rx side equalization.

A processing flow for DL data decoding on the Rx side (e.g., at the XR device) may be based on the existence of allocated pre-equalized DMRS and on a configured default behavior and may, for a default decoding without Rx side equalization, follow the following steps: (1) attempt to decode the DL data without Rx side equalization, (2) if CRC fails, then check if there is a pre-equalized DMRS in the current slot or in a previous slot within a threshold time and/or number of slots (e.g., in a known or configured lookback window) that allows the XR device to acquire a DL channel estimation, (3) if there is a pre-equalized DMRS in the current slot or in a previous slot within a threshold time and/or number of slots, apply Rx side equalization for the DL data decoding (where if the pre-equalized DMRS is associated with a previous slot and had already been used to calculate an equalization matrix, the XR device may use the previously calculated equalization matrix. The “lookback” window from the current slot (e.g., where the XR device searches for pre-equalized DMRS), in some aspects, may be limited (e.g., may span 1 to 3 slots) based on the usefulness/aging of the pre-equalized DMRS and may be RRC configured by the UE.

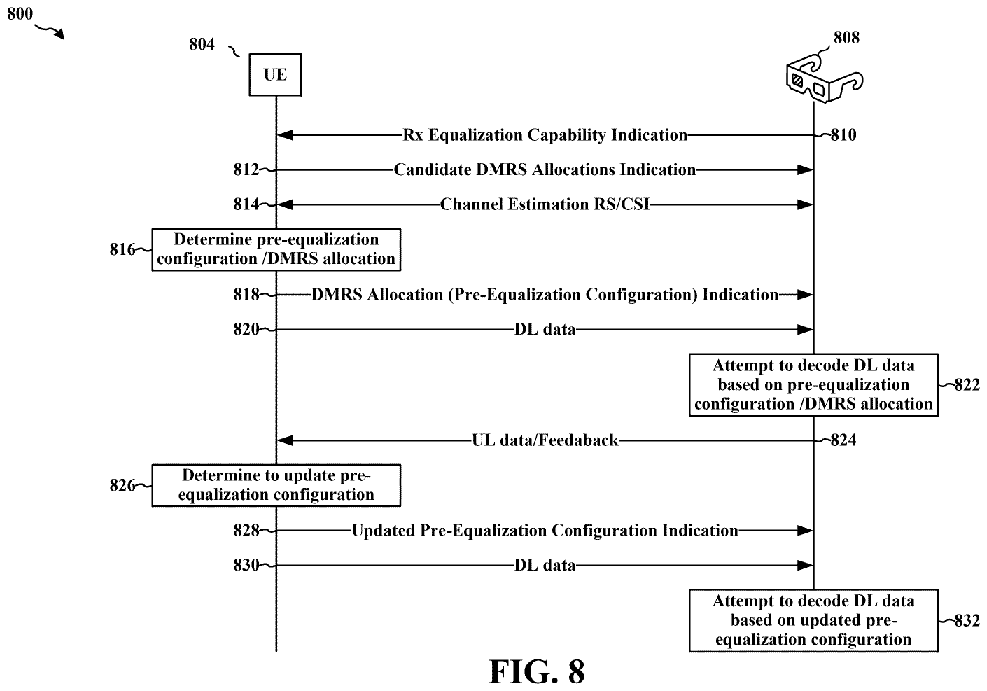

FIG. 8 is a call flow diagram 800 illustrating a method of wireless communication in accordance with some aspects of the disclosure. The method is illustrated in relation to an XR device 808 and a UE 804 (e.g., as an example of a companion wireless device). The functions ascribed to the UE 804, in some aspects, may be performed by one or more components of a wireless device supporting communication with one or more network entities/nodes/devices. Accordingly, references to “transmitting” in the description below may be understood to refer to a first component of the UE 804 (or the XR device 808) outputting (or providing) an indication of the content of the transmission to be transmitted by a different component of the UE 804 (or the XR device 808). Similarly, references to “receiving” in the description below may be understood to refer to a first component of the UE 804 (or the XR device 808) receiving a transmitted signal and outputting (or providing) the received signal (or information based on the received signal) to a different component of the UE 804 (or the XR device 808).

The XR device 808 may transmit, and the UE 804 may receive, an Rx equalization capability indication 810 indicating a capability of the XR device 808 to perform an (Rx side) equalization operation. In some aspects, the Rx equalization capability indication 810 may include an indication of a maximum number of equalization operations that the wireless device is capable of performing during a specified time period. The maximum number of equalization operations, in some aspects, may be based on limits for power consumption and/or heat generation/dissipation at the XR device.

Based on receiving the Rx equalization capability indication 810, the UE 804 may transmit, and the XR device 808 may receive a set of candidate DMRS allocations in a candidate DMRS allocations indication 812. In some aspects, each possible allocation of resources in the set of candidate DMRS allocations (e.g., one or more possible allocations) includes resources for a pre-equalized DMRS in less than all the slots within the set of slots associated with the same pre-equalization. In some aspects, the set of candidate DMRS allocations may further be associated with a default decoding behavior (e.g., a first decoding with, or without, Rx side equalization).

The UE 804 and the XR device 808 may exchange transmissions 814 associated with channel estimation. The transmissions 814, in some aspects, may include UL RS and/or a non-equalized DL RS and CSI (or a CSI report), when channel reciprocity is, or is not, assumed, respectively. Based on the transmission 814, the UE 804 may, at 816, determine a pre-equalization configuration including a DMRS allocation from the set of candidate DMRS allocations. The determination at 816, in some aspects, may further be based on one or more of an estimated channel time correlation evaluated based on the transmissions 814, a retransmission rate associated with preceding transmissions to the wireless device; a bit rate associated with a communication from the UE to the wireless device; an available link capacity of a link between the UE and the wireless device; a latency characteristic of the link between the UE and the wireless device; a channel time correlation measurement; a channel mobility characteristic; movement tracking information of the wireless device; a battery level indication from the wireless device; or a set of ACKs or NACKs from the XR device in relation to a plurality of preceding transmissions for the wireless device some of which may be indicated by the XR device 808 (e.g., in an UL transmission or in association with the Rx equalization capability indication 810). For example, based on an indication that a particular slot index is associated with at least a threshold failure rate (e.g., for a decoding without equalization) over a number of jumbo allocations while being successfully decoded with Rx side equalization, a pre-equalization configuration may include both a DMRS allocation and an indication for the XR device to omit a decoding without equalization and to perform the Rx side equalization decoding for the particular slot index (e.g., a default Rx side equalization for the particular slot).

In some aspects, the resources associated with the pre-equalized DMRS are associated with at least one of one or more non-adjacent slots and/or a set of frequency resources separated by more than two sub-carriers from other frequency resources in a same symbol. In some aspects, the set of candidate DMRS allocations may indicate, for each slot in the set of slots associated with the same pre-equalization, an earliest slot of the set of slots associated with the same pre-equalization including the pre-equalized DMRS that may be used to perform the equalization operation (e.g., the Rx side equalization).

The UE 804 may transmit, and the XR device 808 may receive, a DMRS allocation indication 818 (an indication of a particular DMRS allocation in the set of candidate DMRS allocations and/or additional indications of other pre-equalization configuration such as a size of a lookback window or a default decoding operation for one or more slot indexes). As discussed above, the indication of the allocation of resources associated with the pre-equalized DMRS for the equalization operation may be for less than all slots within a set of slots associated with a same pre-equalization. In some aspects, the resources associated with the pre-equalized DMRS may be associated with at least one of one or more non-adjacent slots or a set of frequency resources separated by more than two sub-carriers from other frequency resources in a same symbol. The DMRS allocation indication 818, in some aspects, may be transmitted via one of DCI or a MAC-CE, where a new field may be introduced or an existing field may be re-purposed to support DMRS allocation indication 818.

The UE 804 may, based on the indicated DMRS allocation, may transmit, and the XR device 808 may receive, DL data 820 using the pre-equalization determined at 816. The DL data 820, in some aspects, may include related pre-equalization DMRS in the resources indicated in the DMRS allocation indication 818. The XR device 808 may, at 822, attempt to decode the DL data 820 based on the pre-equalization configuration and/or DMRS allocation. In some aspects, attempting, at 822, to decode the DL data 820, may include performing a decoding without an equalization operation for pre-equalized DL data in at least a first set of slots and, if the non-equalization based decoding fails a CRC, the XR device 808 may perform a decoding with an equalization operation based on the pre-equalized DMRS. If the DMRS allocation indication 818 includes an indication for the XR device 808 to perform the equalization operation as a default decoding mechanism, the attempt, at 822, to decode the DL data 820 may include refraining from decoding the pre-equalized data transmission without an equalization operation and decoding (attempting to decode) the pre-equalized data transmission by performing the equalization operation based on the first pre-equalized DMRS.

In some aspects, the XR device 808 may attempt, at 822, to decode the DL data 820 in a first slot using an equalization operation based on a pre-equalized DMRS included in the first slot. In some aspects, for a subsequent slot for which the first slot is within a lookback window, the XR device 808 may attempt, at 822, to decode the DL data 820 in the subsequent slot based on the equalization performed for the first slot (e.g., may reuse the calculated equalization matrix) or if the first slot was able to be decoded without an equalization, the attempt, at 822, to decode the DL data 820 in the subsequent slot may include calculating the equalization matrix based on the pre-equalized DMRS included in the first slot.

The XR device 808 may transmit, and the UE 804 may receive, UL data and/or feedback 824. The UL data and/or feedback 824 may include CSI (or a CSI report) as well as one or more ACKs/NACKs. The UE 804 may then determine, at 826, to update (or maintain/retain) the DMRS allocation and/or the pre-equalization configuration based on the feedback. In some aspects, the feedback may indicate one or more slot indexes associated with non-equalization based decoding above a threshold rate and the updated DMRS allocation and/or pre-equalization configuration determined at 826 may indicate for the XR device 808 to omit a performance of a first decoding operation unassociated with the equalization operation and to perform the equalization operation and an associated second decoding operation based on the equalization operation (e.g., to configure the default decoding be an equalization-based decoding).

Accordingly, based on the update determined at 826, the UE 804 may transmit, and the XR device 808 may receive, an updated pre-equalization configuration indication 828 and the related DL data 830 based on the indicated pre-equalization configuration. As described in relation to 822, the XR device may, at 832, attempt to decode the DL data 830 based on the updated pre-equalization configuration indication 828. In some aspects, the attempt, at 832, to decode the DL data 830 may be associated with different default operations and/or different decoding operations based on differences in the success of a default and/or fallback decoding method.

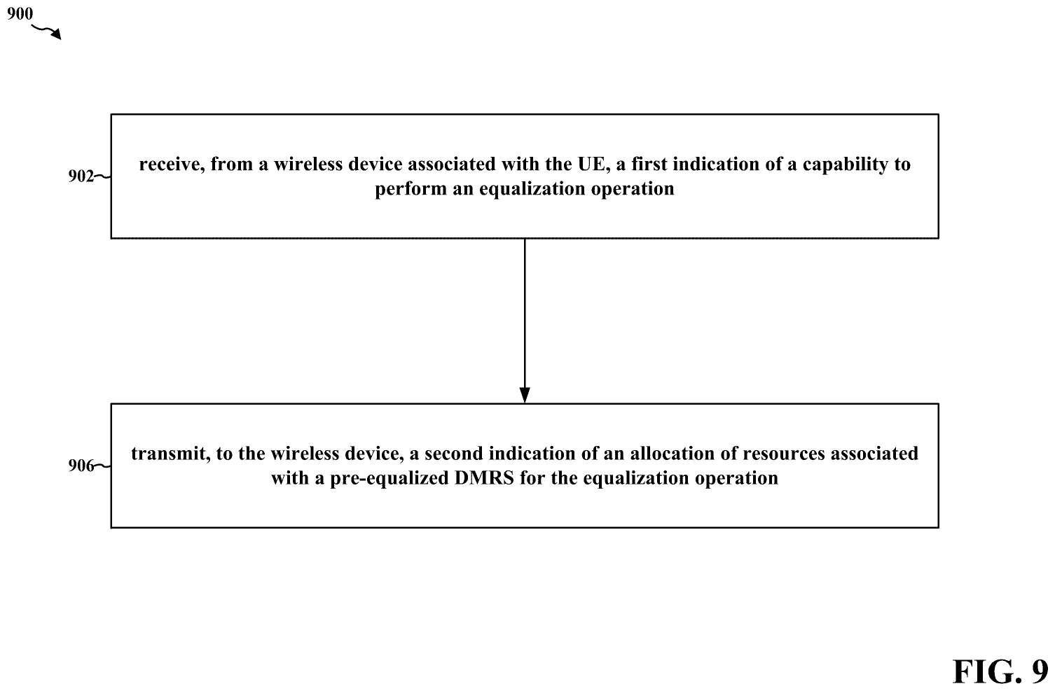

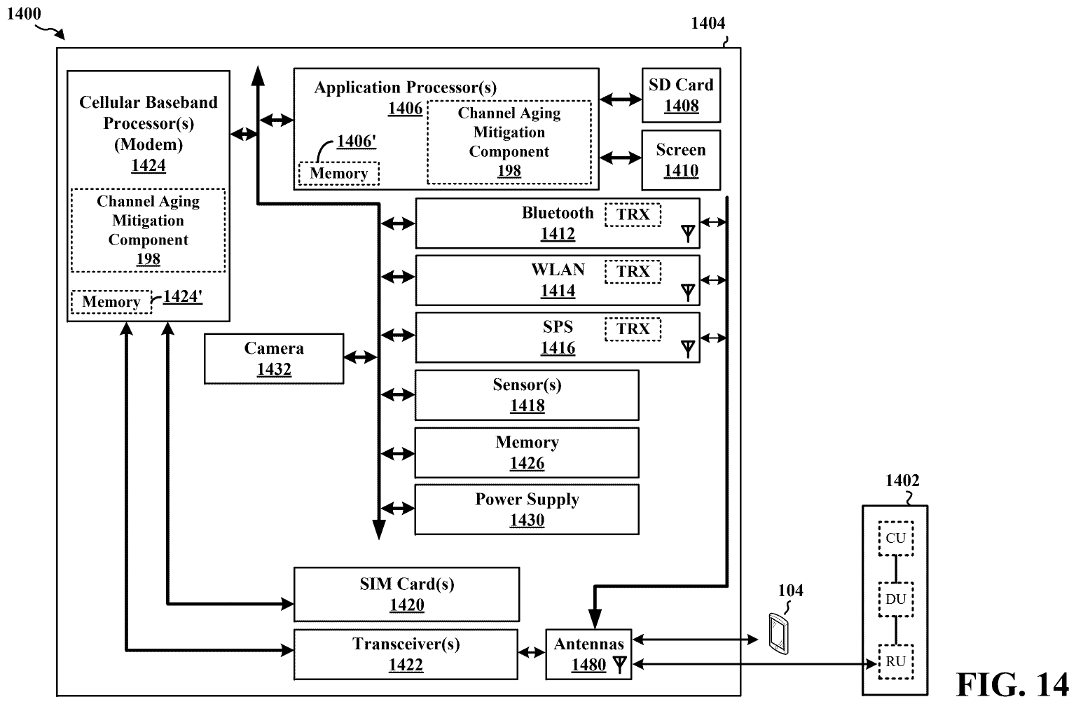

FIG. 9 is a flowchart 900 of a method of wireless communication. The method may be performed by a UE as an example of an XR companion device (e.g., the UE 104, 404, 504, 804; the apparatus 1404). At 902, the UE may receive, from a wireless device associated with the UE, a first indication of a capability to perform an equalization operation. For example, 902 may be performed by application processor(s) 1406, cellular baseband processor(s) 1424, transceiver(s) 1422, antenna(s) 1480, and/or channel aging mitigation component 198 of FIG. 14. In some aspects, the first indication of the capability to perform the equalization operation includes an indication of a maximum number of equalization operations that the wireless device is capable of performing during a specified time period. For example, referring to FIG. 8, the UE 804 may receive the Rx equalization capability indication 810.

In some aspects, the UE may transmit, to the wireless device, a set of one or more possible allocations of resources associated with a pre-equalized DMRS. Each possible allocation of resources in the set of one or more possible allocations, in some aspects, may include resources in less than all the slots within the set of slots associated with the same pre-equalization. For example, referring to FIG. 8, the UE 804 may transmit the candidate DMRS allocations indication 812.

At 906, the UE may transmit, to the wireless device, a second indication of an allocation of resources associated with a pre-equalized DMRS for the equalization operation. For example, 906 may be performed by application processor(s) 1406, cellular baseband processor(s) 1424, transceiver(s) 1422, antenna(s) 1480, and/or channel aging mitigation component 198 of FIG. 14. In some aspects, the allocation of resources is for less than all slots within a set of slots associated with a same pre-equalization. The second indication, in some aspects, may include a third indication of a selected allocation from the set of one or more possible allocations. In some aspects, the second indication may be included in one of DCI and/or a MAC-CE. For example, referring to FIG. 8, the UE 804 may transmit the DMRS allocation indication 818.

In some aspects, the UE may provide, for each slot in the set of slots associated with the same pre-equalization, an indication of an earliest slot of the set of slots associated with the same pre-equalization including the pre-equalized DMRS that may be used to perform the equalization operation. In some aspects, using the pre-equalized DMRS at the XR device to perform the equalization operation for a first slot not including the pre-equalized DMRS may include using an equalization calculated based on the pre-equalized DMRS included in a second slot that precedes the first slot and is no earlier than the earliest slot. For example, referring to FIG. 8, the UE 804 may transmit the DMRS allocation indication 818.

The UE, in some aspects, may provide, for a set of one or more slots, an indication to omit a performance of a first decoding operation unassociated with the equalization operation and to perform the equalization operation and an associated second decoding operation based on the equalization operation. Referring to FIG. 8, for example, the UE 804 may transmit the DMRS allocation indication 818 and/or the updated pre-equalization configuration indication 828 (e.g., including the indication of the default operation being an equalization operation).

In some aspects, the UE may transmit, using a first pre-equalization, data to the wireless device via the set of slots. Referring to FIG. 8, for example, the UE 804 may transmit the DL data 820 and/or DL data 830. The UE, in some aspects, may transmit, using the first pre-equalization, the pre-equalized DMRS based on the allocation of the resources. Referring to FIG. 8, for example, the UE 804 may transmit the DL data 820 and/or DL data 830 including the pre-equalized DMRS.

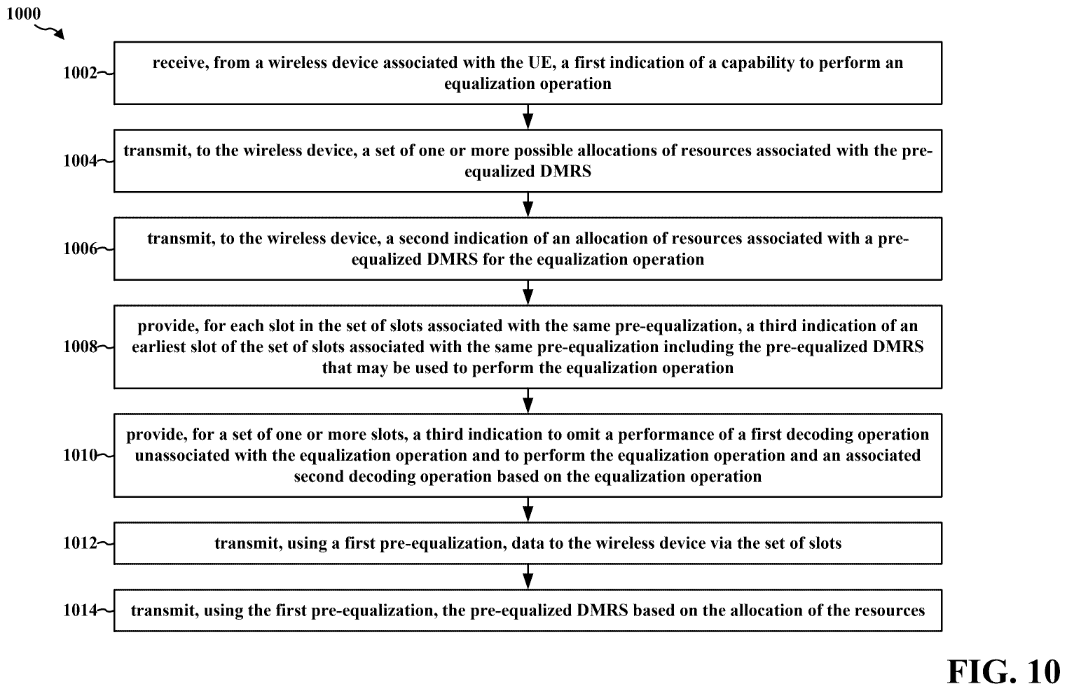

FIG. 10 is a flowchart 1000 of a method of wireless communication. The method may be performed by a UE as an example of an XR companion device (e.g., the UE 104, 404, 504, 804; the apparatus 1404). At 1002, the UE may receive, from a wireless device associated with the UE, a first indication of a capability to perform an equalization operation. For example, 1002 may be performed by application processor(s) 1406, cellular baseband processor(s) 1424, transceiver(s) 1422, antenna(s) 1480, and/or channel aging mitigation component 198 of FIG. 14. In some aspects, the first indication of the capability to perform the equalization operation may include an indication of a maximum number of equalization operations that the wireless device is capable of performing during a specified time period. For example, referring to FIG. 8, the UE 804 may receive the Rx equalization capability indication 810.

At 1004, the UE may transmit, to the wireless device, a set of one or more possible allocations of resources associated with a pre-equalized DMRS. For example, 1004 may be performed by application processor(s) 1406, cellular baseband processor(s) 1424, transceiver(s) 1422, antenna(s) 1480, and/or channel aging mitigation component 198 of FIG. 14. Each possible allocation of resources in the set of one or more possible allocations, in some aspects, may include resources in less than all the slots within the set of slots associated with the same pre-equalization. For example, referring to FIG. 8, the UE 804 may transmit the candidate DMRS allocations indication 812.

At 1006, the UE may transmit, to the wireless device, a second indication of an allocation of resources associated with a pre-equalized DMRS for the equalization operation. For example, 1006 may be performed by application processor(s) 1406, cellular baseband processor(s) 1424, transceiver(s) 1422, antenna(s) 1480, and/or channel aging mitigation component 198 of FIG. 14. In some aspects, the allocation of resources is for less than all slots within a set of slots associated with a same pre-equalization. The second indication, in some aspects, may include a third indication of a selected allocation from the set of one or more possible allocations. In some aspects, the second indication may be included in one of DCI and/or a MAC-CE. For example, referring to FIG. 8, the UE 804 may transmit the DMRS allocation indication 818.

At 1008, the UE may provide, for each slot in the set of slots associated with the same pre-equalization, an indication of an earliest slot of the set of slots associated with the same pre-equalization including the pre-equalized DMRS that may be used to perform the equalization operation. For example, 1008 may be performed by application processor(s) 1406, cellular baseband processor(s) 1424, transceiver(s) 1422, antenna(s) 1480, and/or channel aging mitigation component 198 of FIG. 14. In some aspects, using the pre-equalized DMRS at the XR device to perform the equalization operation for a first slot not including the pre-equalized DMRS may include using an equalization calculated based on the pre-equalized DMRS included in a second slot that precedes the first slot and is no earlier than the earliest slot. For example, referring to FIG. 8, the UE 804 may transmit the DMRS allocation indication 818.

At 1010, the UE may provide, for a set of one or more slots, an indication to omit a performance of a first decoding operation unassociated with the equalization operation and to perform the equalization operation and an associated second decoding operation based on the equalization operation. For example, 1010 may be performed by application processor(s) 1406, cellular baseband processor(s) 1424, transceiver(s) 1422, antenna(s) 1480, and/or channel aging mitigation component 198 of FIG. 14. Referring to FIG. 8, for example, the UE 804 may transmit the DMRS allocation indication 818 and/or the updated pre-equalization configuration indication 828 (e.g., including the indication of the default operation being an equalization operation).

At 1012, the UE may transmit, using a first pre-equalization, data to the wireless device via the set of slots. For example, 1012 may be performed by application processor(s) 1406, cellular baseband processor(s) 1424, transceiver(s) 1422, antenna(s) 1480, and/or channel aging mitigation component 198 of FIG. 14. Referring to FIG. 8, for example, the UE 804 may transmit the DL data 820 and/or DL data 830.

At 1014, the UE may transmit, using the first pre-equalization, the pre-equalized DMRS based on the allocation of the resources. For example, 1014 may be performed by application processor(s) 1406, cellular baseband processor(s) 1424, transceiver(s) 1422, antenna(s) 1480, and/or channel aging mitigation component 198 of FIG. 14. Referring to FIG. 8, for example, the UE 804 may transmit the DL data 820 and/or DL data 830 including the pre-equalized DMRS.

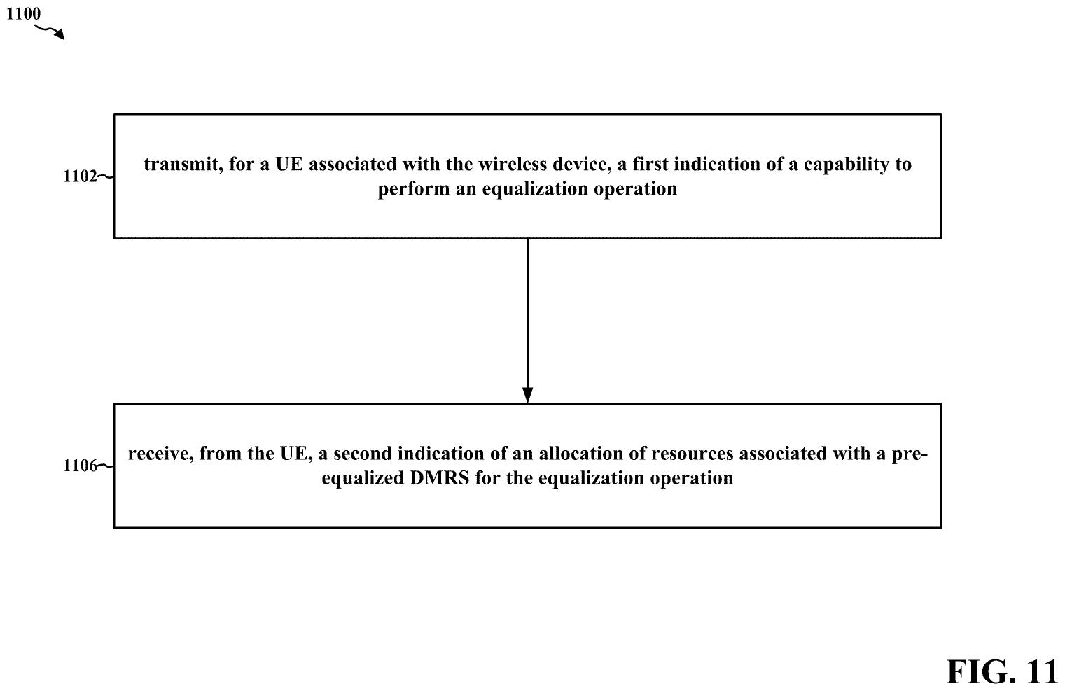

FIG. 11 is a flowchart 1100 of a method of wireless communication. The method may be performed by a wireless device such as an XR device (e.g., the XR device 108, 408, 508, 808; the apparatus 1404). At 1102, the XR device may transmit, for a UE associated with the XR device, a first indication of a capability to perform an equalization operation. For example, 1102 may be performed by application processor(s) 1406, cellular baseband processor(s) 1424, transceiver(s) 1422, antenna(s) 1480, and/or channel aging mitigation component 198 of FIG. 14. In some aspects, the first indication of the capability to perform the equalization operation may include an indication of a maximum number of equalization operations that the wireless device is capable of performing during a specified time period. For example, referring to FIG. 8, the XR device 808 may transmit the Rx equalization capability indication 810.

In some aspects, the XR device may receive, from the UE, a set of one or more possible allocations of resources associated with the pre-equalized DMRS. Each possible allocation of resources in the set of one or more possible allocations, in some aspects, may include resources in less than all the slots within the set of slots associated with the same pre-equalization. For example, referring to FIG. 8, the XR device 808 may receive the candidate DMRS allocations indication 812.

At 1106, the XR device may receive, from the UE, a second indication of an allocation of resources associated with a pre-equalized DMRS for the equalization operation. For example, 1106 may be performed by application processor(s) 1406, cellular baseband processor(s) 1424, transceiver(s) 1422, antenna(s) 1480, and/or channel aging mitigation component 198 of FIG. 14. In some aspects, the allocation of resources is for less than all slots within a set of slots associated with a same pre-equalization. The second indication, in some aspects, may include a third indication of a selected allocation from the set of one or more possible allocations. In some aspects, the second indication may be included in one of DCI and/or a MAC-CE. For example, referring to FIG. 8, the XR device 808 may receive the DMRS allocation indication 818.

In some aspects, the XR device may receive, for each slot in the set of slots associated with the same pre-equalization, an indication of an earliest slot of the set of slots associated with the same pre-equalization including the pre-equalized DMRS that may be used to perform the equalization operation. Referring to FIG. 8, for example, the XR device 808 may receive the DMRS allocation indication 818. The XR device, in some aspects, may receive for a set of one or more slots, a third indication for the XR device to omit a performance of a first decoding operation unassociated with the equalization operation and to perform the equalization operation and an associated second decoding operation based on the equalization operation. Referring to FIG. 8, for example, the XR device 808 may receive the DMRS allocation indication 818 and/or the updated pre-equalization configuration indication 828 (e.g., including the indication of the default operation being an equalization operation).

The XR device, in some aspects, may receive pre-equalized data associated with a first pre-equalization via the set of slots. In some aspects, the pre-equalized data may be received in a particular slot in a set of slots. Referring to FIG. 8, for example, the XR device 808 may receive the DL data 820 and/or DL data 830. In some aspects, the XR device may receive the pre-equalized DMRS associated with the first pre-equalization based on the allocation of the resources. Referring to FIG. 8, for example, the XR device 808 may receive the DL data 820 and/or DL data 830 including the pre-equalized DMRS.

In some aspects, the XR device may decode the pre-equalized data transmission. In some aspects, decoding the pre-equalized data transmission received in the particular slot may include a first decoding attempt without equalization, and if the first decoding attempt fails, the XR device may determine whether a pre-equalized DMRS was received within a lookback window (e.g., if the pre-equalized DMRS was received in a slot that is no earlier than the earliest slot indicated for the particular slot). If a pre-equalized DMRS was received within the lookback window, the XR device may perform a second decoding attempt by performing an equalization operation based on the pre-equalized DMRS. Performing the equalization operation based on the pre-equalized DMRS, in some aspects may include generating a channel estimation (or calculating an equalization matrix) based on the pre-equalized DMRS if it had not yet been generated and/or calculated. For example, if the pre-equalized data is received in the same slot as the slot including the pre-equalized DMRS or a second pre-equalized data transmission received in the slot including the pre-equalized DMRS is successfully decoded without performing the equalization operation, the XR device may generate the channel estimation and/or calculate the equalization matrix based on the pre-equalized DMRS. Alternatively, if the pre-equalized DMRS had previously been used to generate the channel estimation and/or calculate an equalization matrix, performing the equalization operation based on the pre-equalized DMRS may include applying, the previously generated channel estimation and/or calculated equalization matrix based on the pre-equalized DMRS.

In some aspects, decoding the pre-equalized data transmission received in the particular slot may include refraining from decoding the pre-equalized data transmission (e.g., omitting a decoding attempt without equalization) and decoding the pre-equalized data transmission by performing the equalization operation based on the first pre-equalized DMRS. In some aspects, this behavior may be configured by a companion device (e.g., a UE) based on one or more historical failures of a decoding without equalization in slots with the same slot index and a knowledge of the DMRS allocation (where the slot is known to be associated with a pre-equalized DMRS transmitted within the lookback window). Performing the equalization operation based on the pre-equalized DMRS, in some aspects may include generating a channel estimation (or calculating an equalization matrix) based on the pre-equalized DMRS or reusing a previously estimated channel and/or calculated equalization matrix. For example, referring to FIG. 8, the XR device 808 may, at 822 and/or 832, attempt to decode the DL data 820 and/or the DL data 830 based on the pre-equalization configuration and/or DMRS allocation, where the DL data 820 and/or DL data 830 includes the pre-equalized DMRS.

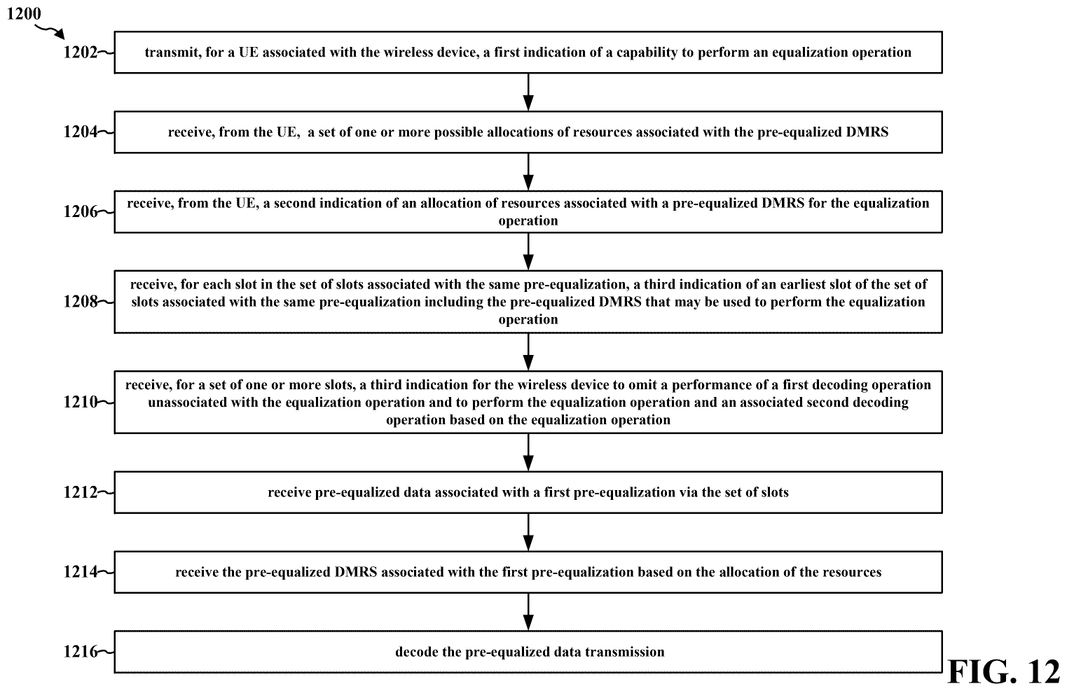

FIG. 12 is a flowchart 1200 of a method of wireless communication. The method may be performed by a wireless device such as an XR device (e.g., the XR device 108, 408, 508, 808; the apparatus 1404). At 1202, the XR device may transmit, for a UE associated with the XR device, a first indication of a capability to perform an equalization operation. For example, 1202 may be performed by application processor(s) 1406, cellular baseband processor(s) 1424, transceiver(s) 1422, antenna(s) 1480, and/or channel aging mitigation component 198 of FIG. 14. In some aspects, the first indication of the capability to perform the equalization operation may include an indication of a maximum number of equalization operations that the wireless device is capable of performing during a specified time period. For example, referring to FIG. 8, the XR device 808 may transmit the Rx equalization capability indication 810.

At 1204, the XR device may receive, from the UE, a set of one or more possible allocations of resources associated with the pre-equalized DMRS. For example, 1204 may be performed by application processor(s) 1406, cellular baseband processor(s) 1424, transceiver(s) 1422, antenna(s) 1480, and/or channel aging mitigation component 198 of FIG. 14. Each possible allocation of resources in the set of one or more possible allocations, in some aspects, may include resources in less than all the slots within the set of slots associated with the same pre-equalization. For example, referring to FIG. 8, the XR device 808 may receive the candidate DMRS allocations indication 812.

At 1206, the XR device may receive, from the UE, a second indication of an allocation of resources associated with a pre-equalized DMRS for the equalization operation. For example, 1206 may be performed by application processor(s) 1406, cellular baseband processor(s) 1424, transceiver(s) 1422, antenna(s) 1480, and/or channel aging mitigation component 198 of FIG. 14. In some aspects, the allocation of resources is for less than all slots within a set of slots associated with a same pre-equalization. The second indication, in some aspects, may include a third indication of a selected allocation from the set of one or more possible allocations. In some aspects, the second indication may be included in one of DCI and/or a MAC-CE. For example, referring to FIG. 8, the XR device 808 may receive the DMRS allocation indication 818.

At 1208, the XR device may receive, for each slot in the set of slots associated with the same pre-equalization, an indication of an earliest slot of the set of slots associated with the same pre-equalization including the pre-equalized DMRS that may be used to perform the equalization operation. For example, 1208 may be performed by application processor(s) 1406, cellular baseband processor(s) 1424, transceiver(s) 1422, antenna(s) 1480, and/or channel aging mitigation component 198 of FIG. 14. Referring to FIG. 8, for example, the XR device 808 may receive the DMRS allocation indication 818.

At 1210, the XR device may receive for a set of one or more slots, a third indication for the XR device to omit a performance of a first decoding operation unassociated with the equalization operation and to perform the equalization operation and an associated second decoding operation based on the equalization operation. For example, 1210 may be performed by application processor(s) 1406, cellular baseband processor(s) 1424, transceiver(s) 1422, antenna(s) 1480, and/or channel aging mitigation component 198 of FIG. 14. Referring to FIG. 8, for example, the XR device 808 may receive the DMRS allocation indication 818 and/or the updated pre-equalization configuration indication 828 (e.g., including the indication of the default operation being an equalization operation).

At 1212, the XR device may receive pre-equalized data associated with a first pre-equalization via the set of slots. For example, 1212 may be performed by application processor(s) 1406, cellular baseband processor(s) 1424, transceiver(s) 1422, antenna(s) 1480, and/or channel aging mitigation component 198 of FIG. 14. In some aspects, the pre-equalized data may be received in a particular slot in a set of slots. Referring to FIG. 8, for example, the XR device 808 may receive the DL data 820 and/or DL data 830.

At 1214, the XR device may receive the pre-equalized DMRS associated with the first pre-equalization based on the allocation of the resources. For example, 1214 may be performed by application processor(s) 1406, cellular baseband processor(s) 1424, transceiver(s) 1422, antenna(s) 1480, and/or channel aging mitigation component 198 of FIG. 14. Referring to FIG. 8, for example, the XR device 808 may receive the DL data 820 and/or DL data 830 including the pre-equalized DMRS.

At 1216, the XR device may decode the pre-equalized data transmission. For example, 1216 may be performed by application processor(s) 1406, cellular baseband processor(s) 1424, transceiver(s) 1422, antenna(s) 1480, and/or channel aging mitigation component 198 of FIG. 14. In some aspects, decoding the pre-equalized data transmission received in the particular slot may include a first decoding attempt without equalization, and if the first decoding attempt fails, the XR device may determine whether a pre-equalized DMRS was received within a lookback window (e.g., if the pre-equalized DMRS was received in a slot that is no earlier than the earliest slot indicated for the particular slot). If a pre-equalized DMRS was received within the lookback window, the XR device may perform a second decoding attempt by performing an equalization operation based on the pre-equalized DMRS. Performing the equalization operation based on the pre-equalized DMRS, in some aspects may include generating a channel estimation (or calculating an equalization matrix) based on the pre-equalized DMRS if it had not yet been generated and/or calculated. For example, if the pre-equalized data is received in the same slot as the slot including the pre-equalized DMRS or a second pre-equalized data transmission received in the slot including the pre-equalized DMRS is successfully decoded without performing the equalization operation, the XR device may generate the channel estimation and/or calculate the equalization matrix based on the pre-equalized DMRS. Alternatively, if the pre-equalized DMRS had previously been used to generate the channel estimation and/or calculate an equalization matrix, performing the equalization operation based on the pre-equalized DMRS may include applying, the previously generated channel estimation and/or calculated equalization matrix based on the pre-equalized DMRS.

In some aspects, decoding the pre-equalized data transmission received in the particular slot may include refraining from decoding the pre-equalized data transmission (e.g., omitting a decoding attempt without equalization) and decoding the pre-equalized data transmission by performing the equalization operation based on the first pre-equalized DMRS. In some aspects, this behavior may be configured by a companion device (e.g., a UE) based on one or more historical failures of a decoding without equalization in slots with the same slot index and a knowledge of the DMRS allocation (where the slot is known to be associated with a pre-equalized DMRS transmitted within the lookback window). Performing the equalization operation based on the pre-equalized DMRS, in some aspects may include generating a channel estimation (or calculating an equalization matrix) based on the pre-equalized DMRS or reusing a previously estimated channel and/or calculated equalization matrix. For example, referring to FIG. 8, the XR device 808 may, at 822 and/or 832, attempt to decode the DL data 820 and/or the DL data 830 based on the pre-equalization configuration and/or DMRS allocation, where the DL data 820 and/or DL data 830 includes the pre-equalized DMRS.

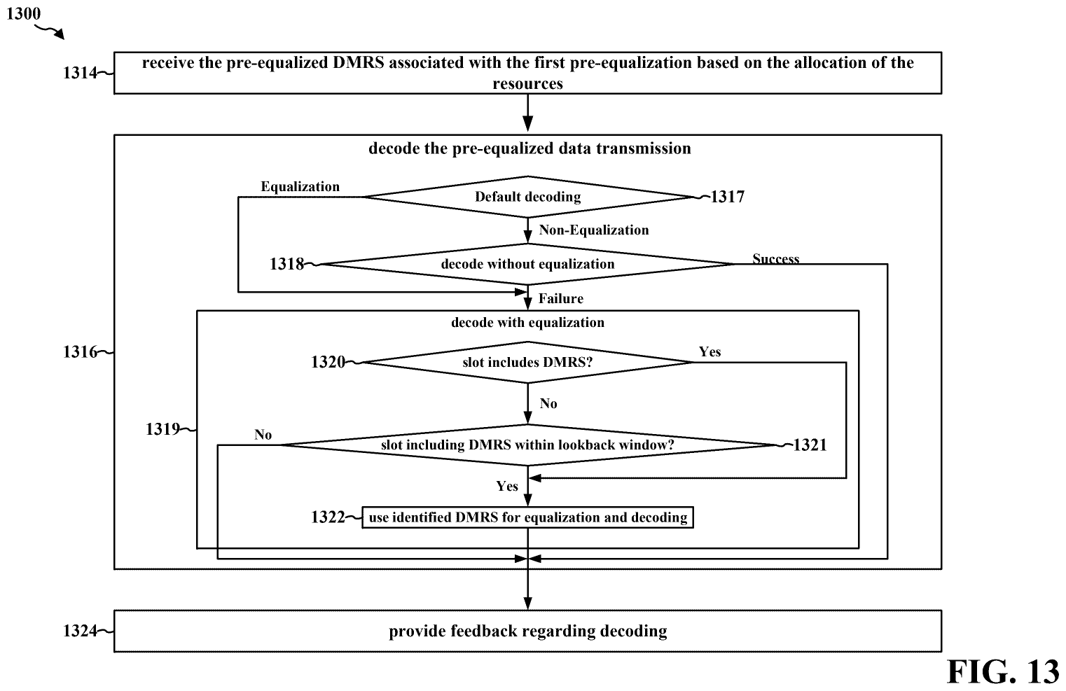

FIG. 13 is a flowchart 1300 of a method of wireless communication. The method may be performed by a wireless device such as an XR device (e.g., the XR device 108, 408, 508, 808; the apparatus 1404). At 1314, the XR device may receive the pre-equalized DMRS associated with the first pre-equalization based on the allocation of the resources as described in relation to 1214 of FIG. 12. In some aspects, receiving the pre-equalized DMRS may be preceded by the other operations and/or steps described in relation to 1202-1212 of FIG. 12. For example, 1314 may be performed by application processor(s) 1406, cellular baseband processor(s) 1424, transceiver(s) 1422, antenna(s) 1480, and/or channel aging mitigation component 198 of FIG. 14. Referring to FIG. 8, for example, the XR device 808 may receive the DL data 820 and/or DL data 830 including the pre-equalized DMRS.

At 1316, the XR device may decode a received pre-equalized data transmission. In some aspects, decoding, at 1316, a pre-equalized data transmission received in a particular slot may include a determination, at 1317, of a default decoding. In some aspects, a default decoding may (without explicit configuration) be a non-equalization decoding to reduce power consumption, but may be configurable to be an Rx side equalization based decoding. Accordingly, if the default decoding is a decoding without equalization (e.g., a non-equalization decoding), the XR device may, at 1318 attempt to decode the pre-equalized data transmission without an equalization operation. If the decoding without equalization is successful (e.g., passes a CRC) the XR may, at 1324, provide feedback regarding the decoding (e.g., provide an ACK indicating that the decoding was successful).

If the decoding at 1318 is not successful, or the default decoding identified at 1317 is an equalization based decoding, the XR may, at 1319, perform an equalization based decoding. To perform the equalization based decoding at 1319, the XR device may, in some aspects, determine whether the current slot (e.g., the slot including the pre-equalized data transmission) includes a pre-equalized DMRS. If the XR device determines, at 1320, that the slot does not include a pre-equalized DMRS, the XR device may determine, at 1321, whether a pre-equalized DMRS was received in, or exists for, a slot that is no earlier than an indicated earliest slot of the set of slots associated with the same pre-equalization that may be used to perform the equalization operation (e.g., whether a pre-equalized DMRS exists within a lookback window). If the XR device determines, at 1320 or at 1321, that a pre-equalized DMRS is included (was received) in the current slot or exists and/or is available for a channel estimation and/or equalization matrix calculation, the XR device, at 1322, may use the identified pre-equalized DMRS to perform an equalization operation and decoding (e.g., an equalization based decoding). Performing the equalization operation, in some aspects, may include generating the channel estimation and/or calculating the equalization matrix based on the identified pre-equalized DMRS. Alternatively, if the identified pre-equalized DMRS had previously been used to generate a channel estimation and/or calculate an equalization matrix, performing the equalization operation based on the identified pre-equalized DMRS may include applying the previously generated channel estimation and/or calculated equalization matrix based on the pre-equalized DMRS. Based on the success and/or failure of the decoding, the XR device may provide, at 1324, the appropriate feedback (e.g., an ACK or NACK indicating a successful or failed decoding, respectively). If the XR device determines, at 1321, that no pre-equalized DMRS was received, or exists, the XR device may determine that the decoding has failed and the XR may, at 1324, provide feedback regarding the decoding (e.g., provide a NACK indicating that the decoding failed). For example, 1316-1324 may be performed by application processor(s) 1406, cellular baseband processor(s) 1424, transceiver(s) 1422, antenna(s) 1480, and/or channel aging mitigation component 198 of FIG. 14. Referring to FIG. 8, for example, the XR device 808 may, at 822 and/or 832, attempt to decode the DL data 820 and/or the DL data 830 based on the pre-equalization configuration and/or DMRS allocation, where the DL data 820 and/or DL data 830 includes the pre-equalized DMRS and transmit feedback in UL data and/or feedback 824.

FIG. 14 is a diagram 1400 illustrating an example of a hardware implementation for an apparatus 1404. The apparatus 1404 may be a UE, a component of a UE, or may implement UE functionality. In some aspects, the apparatus 1404 may include at least one cellular baseband processor 1424 (also referred to as a modem) coupled to one or more transceivers 1422 (e.g., cellular RF transceiver). The cellular baseband processor(s) 1424 may include at least one on-chip memory 1424′. In some aspects, the apparatus 1404 may further include one or more subscriber identity modules (SIM) cards 1420 and at least one application processor 1406 coupled to a secure digital (SD) card 1408 and a screen 1410. The application processor(s) 1406 may include on-chip memory 1406′. In some aspects, the apparatus 1404 may further include a Bluetooth module 1412, a WLAN module 1414, an SPS module 1416 (e.g., GNSS module), one or more sensor modules 1418 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1426, a power supply 1430, and/or a camera 1432. The Bluetooth module 1412, the WLAN module 1414, and the SPS module 1416 may include an on-chip transceiver (TRX) (or in some cases, just a receiver (RX)). The Bluetooth module 1412, the WLAN module 1414, and the SPS module 1416 may include their own dedicated antennas and/or utilize one or more antennas 1480 for communication. The cellular baseband processor(s) 1424 communicates through the transceiver(s) 1422 via the one or more antennas 1480 with the UE 104 and/or with an RU associated with a network entity 1402. The cellular baseband processor(s) 1424 and the application processor(s) 1406 may each include a computer-readable medium/memory 1424′, 1406′, respectively. The additional memory modules 1426 may also be considered a computer-readable medium/memory. Each computer-readable medium/memory 1424′, 1406′, 1426 may be non-transitory. The cellular baseband processor(s) 1424 and the application processor(s) 1406 are each responsible for general processing, including the execution of software stored on the computer-readable medium/memory. The software, when executed by the cellular baseband processor(s) 1424/application processor(s) 1406, causes the cellular baseband processor(s) 1424/application processor(s) 1406 to perform the various functions described supra. The computer-readable medium/memory may also be used for storing data that is manipulated by the cellular baseband processor(s) 1424/application processor(s) 1406 when executing software. The cellular baseband processor(s) 1424/application processor(s) 1406 may be a component of the UE 350 and may include the at least one memory 360 and/or at least one of the TX processor 368, the RX processor 356, and the controller/processor 359. In one configuration, the apparatus 1404 may be at least one processor chip (modem and/or application) and include just the cellular baseband processor(s) 1424 and/or the application processor(s) 1406, and in another configuration, the apparatus 1404 may be the entire UE (e.g., see UE 350 of FIG. 3) and include the additional modules of the apparatus 1404.

As discussed supra, the channel aging mitigation component 198 may be configured to receive, from a wireless device associated with the UE, a first indication of a capability to perform an equalization operation and transmit, to the wireless device, a second indication of an allocation of resources associated with a pre-equalized DMRS for the equalization operation, wherein the allocation of resources is for less than all slots within a set of slots associated with a same pre-equalization. In certain aspects, the channel aging mitigation component 198 may be configured to transmit, for a UE associated with the wireless device, a first indication of a capability to perform an equalization operation and receive, from the UE, a second indication of an allocation of resources associated with a pre-equalized DMRS for the equalization operation, wherein the allocation of resources is for less than all slots within a set of slots associated with a same pre-equalization. The channel aging mitigation component 198 may be within the cellular baseband processor(s) 1424, the application processor(s) 1406, or both the cellular baseband processor(s) 1424 and the application processor(s) 1406. The channel aging mitigation component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1404 may include a variety of components configured for various functions. In one configuration, the apparatus 1404, and in particular the cellular baseband processor(s) 1424 and/or the application processor(s) 1406, may include means for receiving, from a wireless device associated with the UE, a first indication of a capability to perform an equalization operation. The apparatus 1404, and in particular the cellular baseband processor(s) 1424 and/or the application processor(s) 1406, may include means for transmitting, to the wireless device, a second indication of an allocation of resources associated with a pre-equalized demodulation reference signal (DMRS) for the equalization operation, wherein the allocation of resources is for less than all slots within a set of slots associated with a same pre-equalization. The apparatus 1404, and in particular the cellular baseband processor(s) 1424 and/or the application processor(s) 1406, may include means for transmitting, to the wireless device, a set of one or more possible allocations of resources associated with the pre-equalized DMRS. The apparatus 1404, and in particular the cellular baseband processor(s) 1424 and/or the application processor(s) 1406, may include means for providing, for each slot in the set of slots associated with the same pre-equalization, a third indication of an earliest slot of the set of slots associated with the same pre-equalization including the pre-equalized DMRS that may be used to perform the equalization operation. The apparatus 1404, and in particular the cellular baseband processor(s) 1424 and/or the application processor(s) 1406, may include means for providing, for a set of one or more slots, a third indication to omit a performance of a first decoding operation unassociated with the equalization operation and to perform the equalization operation and an associated second decoding operation based on the equalization operation. The apparatus 1404, and in particular the cellular baseband processor(s) 1424 and/or the application processor(s) 1406, may include means for transmitting, using a first pre-equalization, data to the wireless device via the set of slots. The apparatus 1404, and in particular the cellular baseband processor(s) 1424 and/or the application processor(s) 1406, may include means for transmitting, using the first pre-equalization, the pre-equalized DMRS based on the allocation of the resources. The apparatus 1404, and in particular the cellular baseband processor(s) 1424 and/or the application processor(s) 1406, may include means for transmitting, for a UE associated with the wireless device, a first indication of a capability to perform an equalization operation. The apparatus 1404, and in particular the cellular baseband processor(s) 1424 and/or the application processor(s) 1406, may include means for receiving, from the UE, a second indication of an allocation of resources associated with a pre-equalized demodulation reference signal (DMRS) for the equalization operation, wherein the allocation of resources is for less than all slots within a set of slots associated with a same pre-equalization. The apparatus 1404, and in particular the cellular baseband processor(s) 1424 and/or the application processor(s) 1406, may include means for receiving, from the UE, a set of one or more possible allocations of resources associated with the pre-equalized DMRS. The apparatus 1404, and in particular the cellular baseband processor(s) 1424 and/or the application processor(s) 1406, may include means for receiving, for a set of one or more slots, a third indication for the wireless device to omit a performance of a first decoding operation unassociated with the equalization operation and to perform the equalization operation and an associated second decoding operation based on the equalization operation. The apparatus 1404, and in particular the cellular baseband processor(s) 1424 and/or the application processor(s) 1406, may include means for receiving, for each slot in the set of slots associated with the same pre-equalization, a third indication of an earliest slot of the set of slots associated with the same pre-equalization including the pre-equalized DMRS that may be used to perform the equalization operation. The apparatus 1404, and in particular the cellular baseband processor(s) 1424 and/or the application processor(s) 1406, may include means for receiving, within a slot in the set of slots, a first pre-equalized DMRS. The apparatus 1404, and in particular the cellular baseband processor(s) 1424 and/or the application processor(s) 1406, may include means for receiving, in an additional slot in the set of slots following the slot in the set of slots, a pre-equalized data transmission. The apparatus 1404, and in particular the cellular baseband processor(s) 1424 and/or the application processor(s) 1406, may include means for refraining from decoding the pre-equalized data transmission. The apparatus 1404, and in particular the cellular baseband processor(s) 1424 and/or the application processor(s) 1406, may include means for decoding the pre-equalized data transmission by performing the equalization operation based on the first pre-equalized DMRS. The apparatus 1404, and in particular the cellular baseband processor(s) 1424 and/or the application processor(s) 1406, may include means for generating, when (1) the additional slot is a same slot as the slot including the first pre-equalized DMRS or (2) a second pre-equalized data transmission received in the slot including the first pre-equalized DMRS is successfully decoded without performing the equalization operation, a channel estimation based on the pre-equalized DMRS. The apparatus 1404, and in particular the cellular baseband processor(s) 1424 and/or the application processor(s) 1406, may include means for applying, when the equalization operation is performed to decode the second pre-equalized data transmission, a previously generated channel estimation based on the pre-equalized DMRS. The apparatus 1404, and in particular the cellular baseband processor(s) 1424 and/or the application processor(s) 1406, may include means for receiving pre-equalized data associated with a first pre-equalization via the set of slots. The apparatus 1404, and in particular the cellular baseband processor(s) 1424 and/or the application processor(s) 1406, may include means for receiving the pre-equalized DMRS associated with the first pre-equalization based on the allocation of the resources. The apparatus 1404 may further include means for performing any of the aspects described in connection with the flowcharts in FIGS. 9 to 13, and/or performed by the UE or the XR device in the communication flow of FIG. 8. The means may be the channel aging mitigation component 198 of the apparatus 1404 configured to perform the functions recited by the means. As described supra, the apparatus 1404 may include the TX processor 368, the RX processor 356, and the controller/processor 359. As such, in one configuration, the means may be the TX processor 368, the RX processor 356, and/or the controller/processor 359 configured to perform the functions recited by the means.

Various aspects relate generally to mitigating the channel aging effect. Some aspects more specifically relate to allocating a pre-equalized DMRS for a subset (e.g., less than all) of the slots within a multi-slot and/or jumbo allocation that will allow the XR device to fallback to Rx side equalization if a low complexity reception attempt (e.g., a decoding without Rx side equalization) fails. In some examples, a wireless device (e.g., a UE) may be configured to receive, from a wireless device associated with the UE, a first indication of a capability to perform an equalization operation and transmit, to the wireless device, a second indication of an allocation of resources associated with a pre-equalized DMRS for the equalization operation, wherein the allocation of resources is for less than all slots within a set of slots associated with a same pre-equalization. In some aspects a wireless device (e.g., an XR device) may be configured to transmit, for a UE associated with the wireless device, a first indication of a capability to perform an equalization operation and receive, from the UE, a second indication of an allocation of resources associated with a pre-equalized DMRS for the equalization operation, wherein the allocation of resources is for less than all slots within a set of slots associated with a same pre-equalization.

Particular aspects of the subject matter described in this disclosure can be implemented to realize one or more of the following potential advantages. In some examples, by allocating the pre-equalized DMRS for the subset of the slots within the multi-slot and/or jumbo allocation, the described techniques can be used to increase the robustness of Tx equalization and reduce a decoding failure rate (and a related number of retransmission events). The reduced decoding failure may lead to an improved link efficiency (associated with a reduced retransmission overhead) and a reduced DL latency. In some aspects, by reducing the probability of DL latency at a tail of the distribution (e.g., the longest DL latencies) may lead to a significant improvement for highly latency sensitive applications. For example, an XR experience may be greatly improved by reducing the long tail of the DL latency distribution. Allocating the pre-equalized DMRS for the subset of the slots within the multi-slot and/or jumbo allocation may also allow for improved spectral efficiency (e.g., using a higher MCS) of a link, allow for relaxed CSI refresh/Tx equalization evaluation rate specifications (e.g., using a longer pre-equalization refresh period), improve a user experience and quality of service (QOS) for the low complexity reception, support modem power consumption and complexity reduction at XR/Rx device (Rx side of the modem) due to “shifting” of equalization procedures and channel, and recurrent neural network (RNN), estimation related complexity and functionality from the XR device (or RedCap UE) to a companion device/UE (or BS), and allow for simplified XR/Rx side modem hardware.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method for wireless communication at a user equipment (UE) comprising: receiving, from a wireless device associated with the UE, a first indication of a capability to perform an equalization operation; and transmitting, to the wireless device, a second indication of an allocation of resources associated with a pre-equalized demodulation reference signal (DMRS) for the equalization operation, wherein the allocation of the resources is for less than all slots within a set of slots associated with a same pre-equalization.

Aspect 2 is the method of aspect any of aspects 1, wherein the first indication of the capability to perform the equalization operation comprises a third indication of a maximum number of slots for which the wireless device is capable of performing the equalization operation during a specified time period.

Aspect 3 is the method of any of aspects 1 and 2, further comprising: transmitting, to the wireless device, a set of one or more possible allocations of resources associated with the pre-equalized DMRS, wherein each possible allocation of the resources in the set of one or more possible allocations comprises resources in less than all the slots within the set of slots associated with the same pre-equalization, and wherein the second indication comprises a third indication of a selected allocation from the set of one or more possible allocations.

Aspect 4 is the method of any of aspects 1 to 3, wherein the resources associated with the pre-equalized DMRS are associated with at least one of one or more non-adjacent slots or a set of frequency resources separated by more than two sub-carriers from other frequency resources in at least a same symbol.

Aspect 5 is the method of aspect 4, wherein the resources associated with the pre-equalized DMRS are associated with the one or more non-adjacent slots, the method further comprising: providing, for each slot in the set of slots associated with the same pre-equalization, a third indication of an earliest slot of the set of slots associated with the same pre-equalization including the pre-equalized DMRS that may be used to perform the equalization operation for the slot.

Aspect 6 is the method of aspect 5, wherein using the pre-equalized DMRS to perform the equalization operation for a first slot not including the pre-equalized DMRS comprises using an equalization calculated based on the pre-equalized DMRS included in a second slot that precedes the first slot and is no earlier than the earliest slot.

Aspect 7 is the method of any of aspects 1 to 6, wherein the second indication is included in one of downlink control information (DCI) or a medium access control (MAC) control element (CE) (MAC-CE).

Aspect 8 is the method of any of aspects 1 to 7, wherein the allocation of the resources associated with the pre-equalized DMRS is further based on one or more of: a retransmission rate associated with preceding transmissions to the wireless device; a bit rate associated with a communication from the UE to the wireless device; an available link capacity of a link between the UE and the wireless device; a latency characteristic of the link between the UE and the wireless device; a channel time correlation measurement; a channel mobility characteristic; movement tracking information of the wireless device; a battery level indication from the wireless device; or a set of acknowledgements (ACKs) or negative ACKs (NACKs) from the wireless device in relation to a plurality of preceding transmissions for the wireless device.

Aspect 9 is the method of any of aspects 1 to 8, further comprising: providing, for a set of one or more slots, a third indication to omit a performance of a first decoding operation unassociated with the equalization operation and to perform the equalization operation and an associated second decoding operation based on the equalization operation.

Aspect 10 is the method of any of aspects 1 to 9, further comprising: transmitting, using a first pre-equalization, data to the wireless device via the set of slots; and transmitting, using the first pre-equalization, the pre-equalized DMRS based on the allocation of the resources.

Aspect 11 is a method for wireless communication at a wireless device comprising: transmitting, for a UE associated with the wireless device, a first indication of a capability to perform an equalization operation; and receiving, from the UE, a second indication of an allocation of resources associated with a pre-equalized demodulation reference signal (DMRS) for the equalization operation, wherein the allocation of resources is for less than all slots within a set of slots associated with a same pre-equalization.

Aspect 12 is the method of aspect 11, wherein the first indication of the capability to perform the equalization operation comprises a third indication of a maximum number of slots for which the wireless device is capable of performing an equalization operation during a specified time period.

Aspect 13 is the method of any of aspects 11 and 12, further comprising: receiving, from the UE, a set of one or more possible allocations of resources associated with the pre-equalized DMRS, wherein each possible allocation of resources in the set of one or more possible allocations comprises resources in less than all the slots within the set of slots associated with the same pre-equalization, and wherein the second indication comprises a third indication of a selected allocation from the set of one or more possible allocations.

Aspect 14 is the method of any of aspects 11 to 13, wherein the resources associated with the pre-equalized DMRS are associated with at least one of one or more non-adjacent slots or a set of frequency resources separated by more than two sub-carriers from other frequency resources in at least a same symbol.

Aspect 15 is the method of aspect 14, wherein the resources associated with the pre-equalized DMRS are associated with the one or more non-adjacent slots the method further comprising: receiving, for each slot in the set of slots associated with the same pre-equalization, a third indication of an earliest slot of the set of slots associated with the same pre-equalization including the pre-equalized DMRS that may be used to perform the equalization operation for the slot.

Aspect 16 is the method of aspect 15, further comprising: receiving, within a slot in the set of slots, a first pre-equalized DMRS; receiving, in an additional slot in the set of slots following the slot in the set of slots, a pre-equalized data transmission, wherein the slot is no earlier than the earliest slot indicated based on the third indication for the additional slot; refraining from decoding the pre-equalized data transmission; and decoding the pre-equalized data transmission by performing the equalization operation based on the first pre-equalized DMRS.

Aspect 17 is the method of aspect 16, wherein performing the equalization operation based on the first pre-equalized DMRS comprises one of: generating, when (1) the additional slot is a same slot as the slot including the first pre-equalized DMRS or (2) a second pre-equalized data transmission received in the slot including the first pre-equalized DMRS is successfully decoded without performing the equalization operation, a channel estimation based on the pre-equalized DMRS; or applying, when the equalization operation is performed to decode the second pre-equalized data transmission, a previously generated channel estimation based on the pre-equalized DMRS.

Aspect 18 is the method of any of aspects 11 to 17, wherein the second indication is included in one of downlink control information (DCI) or a medium access control (MAC) control element (CE) (MAC-CE).

Aspect 19 is the method of any of aspects 11 to 18, further comprising: receiving, for a set of one or more slots, a third indication for the wireless device to omit a performance of a first decoding operation unassociated with the equalization operation and to perform the equalization operation and an associated second decoding operation based on the equalization operation.

Aspect 20 is the method of any of aspects 11 to 19, further comprising: receiving pre-equalized data associated with a first pre-equalization via the set of slots; and receiving the pre-equalized DMRS associated with the first pre-equalization based on the allocation of the resources.

Aspect 21 is an apparatus for wireless communication at a device including a memory and at least one processor coupled to the memory and, based at least in part on information stored in the memory, the at least one processor is configured to implement any of aspects 1 to 10.

Aspect 22 is the apparatus of aspect 21, further including a transceiver or an antenna coupled to the at least one processor.

Aspect 23 is an apparatus for wireless communication at a device including means for implementing any of aspects 1 to 10.

Aspect 24 is a computer-readable medium (e.g., a non-transitory computer-readable medium) storing computer executable code, where the code when executed by a processor causes the processor to implement any of aspects 1 to 10.

Aspect 25 is an apparatus for wireless communication at a device including a memory and at least one processor coupled to the memory and, based at least in part on information stored in the memory, the at least one processor is configured to implement any of aspects 11 to 20.

Aspect 26 is the apparatus of aspect 25, further including a transceiver or an antenna coupled to the at least one processor.

Aspect 27 is an apparatus for wireless communication at a device including means for implementing any of aspects 11 to 20.

Aspect 28 is a computer-readable medium (e.g., a non-transitory computer-readable medium) storing computer executable code, where the code when executed by a processor causes the processor to implement any of aspects 11 to 20.

What is claimed is:

1. An apparatus for wireless communication at a user equipment (UE), comprising:
at least one memory; and
at least one processor coupled to the at least one memory and, based at least in part on stored information that is stored in the at least one memory, the at least one processor, individually or in any combination, is configured to:
receive, from a wireless device associated with the UE, a first indication of a capability to perform an equalization operation; and
transmit, to the wireless device, a second indication of an allocation of resources associated with a pre-equalized demodulation reference signal (DMRS) for the equalization operation, wherein the allocation of the resources is for less than all slots within a set of slots associated with a same pre-equalization.

2. The apparatus of claim 1, wherein the first indication of the capability to perform the equalization operation comprises a third indication of a maximum number of slots for which the wireless device is capable of performing the equalization operation during a specified time period.

3. The apparatus of claim 1, wherein the at least one processor, individually or in any combination, is further configured to:
transmit, to the wireless device, a set of one or more possible allocations of resources associated with the pre-equalized DMRS, wherein each possible allocation of the resources in the set of one or more possible allocations comprises resources in less than all the slots within the set of slots associated with the same pre-equalization, and wherein the second indication comprises a third indication of a selected allocation from the set of one or more possible allocations.

4. The apparatus of claim 1, wherein the resources associated with the pre-equalized DMRS are associated with at least one of one or more non-adjacent slots or a set of frequency resources separated by more than two sub-carriers from other frequency resources in at least a same symbol.

5. The apparatus of claim 4, wherein the resources associated with the pre-equalized DMRS are associated with the one or more non-adjacent slots, wherein the at least one processor, individually or in any combination, is further configured to:
provide, for each slot in the set of slots associated with the same pre-equalization, a third indication of an earliest slot of the set of slots associated with the same pre-equalization including the pre-equalized DMRS that may be used to perform the equalization operation for the slot.

6. The apparatus of claim 5, wherein using the pre-equalized DMRS to perform the equalization operation for a first slot not including the pre-equalized DMRS comprises using an equalization calculated based on the pre-equalized DMRS included in a second slot that precedes the first slot and is no earlier than the earliest slot.

7. The apparatus of claim 1, wherein the second indication is included in one of downlink control information (DCI) or a medium access control (MAC) control element (CE) (MAC-CE).

8. The apparatus of claim 1, wherein the allocation of the resources associated with the pre-equalized DMRS is further based on one or more of:
a retransmission rate associated with preceding transmissions to the wireless device;
a bit rate associated with a communication from the UE to the wireless device;
an available link capacity of a link between the UE and the wireless device;
a latency characteristic of the link between the UE and the wireless device;
a channel time correlation measurement;
a channel mobility characteristic;
movement tracking information of the wireless device;
a battery level indication from the wireless device; or
a set of acknowledgements (ACKs) or negative ACKs (NACKs) from the wireless device in relation to a plurality of preceding transmissions for the wireless device.

9. The apparatus of claim 1, wherein the at least one processor, individually or in any combination, is further configured to:
provide, for a set of one or more slots, a third indication to omit a performance of a first decoding operation unassociated with the equalization operation and to perform the equalization operation and an associated second decoding operation based on the equalization operation.

10. The apparatus of claim 1, further comprising a transceiver or an antenna coupled to the at least one processor, wherein the at least one processor, individually or in any combination, is configured to:
transmit, using a first pre-equalization and via the transceiver or the antenna, data to the wireless device via the set of slots; and
transmit, using the first pre-equalization and via the transceiver or the antenna, the pre-equalized DMRS based on the allocation of the resources.

11. A method for wireless communication at a user equipment (UE) comprising:
receiving, from a wireless device associated with the UE, a first indication of a capability to perform an equalization operation; and
transmitting, to the wireless device, a second indication of an allocation of resources associated with a pre-equalized demodulation reference signal (DMRS) for the equalization operation, wherein the allocation of the resources is for less than all slots within a set of slots associated with a same pre-equalization.

12. The method of claim 11, wherein the first indication of the capability to perform the equalization operation comprises a third indication of a maximum number of slots for which the wireless device is capable of performing the equalization operation during a specified time period.

13. The method of claim 11, further comprising:
transmitting, to the wireless device, a set of one or more possible allocations of resources associated with the pre-equalized DMRS, wherein each possible allocation of the resources in the set of one or more possible allocations comprises resources in less than all the slots within the set of slots associated with the same pre-equalization, and wherein the second indication comprises a third indication of a selected allocation from the set of one or more possible allocations.

14. The method of claim 11, wherein the resources associated with the pre-equalized DMRS are associated with at least one of one or more non-adjacent slots or a set of frequency resources separated by more than two sub-carriers from other frequency resources in at least a same symbol.

15. The method of claim 14, wherein the resources associated with the pre-equalized DMRS are associated with the one or more non-adjacent slots, the method further comprising:
providing, for each slot in the set of slots associated with the same pre-equalization, a third indication of an earliest slot of the set of slots associated with the same pre-equalization including the pre-equalized DMRS that may be used to perform the equalization operation for the slot.

16. The method of claim 11, wherein the second indication is included in one of downlink control information (DCI) or a medium access control (MAC) control element (CE) (MAC-CE).

17. The method of claim 11, wherein the allocation of the resources associated with the pre-equalized DMRS is further based on one or more of:
a retransmission rate associated with preceding transmissions to the wireless device;
a bit rate associated with a communication from the UE to the wireless device;
an available link capacity of a link between the UE and the wireless device;
a latency characteristic of the link between the UE and the wireless device;
a channel time correlation measurement;
a channel mobility characteristic;
movement tracking information of the wireless device;
a battery level indication from the wireless device; or
a set of acknowledgements (ACKs) or negative ACKs (NACKs) from the wireless device in relation to a plurality of preceding transmissions for the wireless device.

18. The method of claim 11, further comprising:
providing, for a set of one or more slots, a third indication to omit a performance of a first decoding operation unassociated with the equalization operation and to perform the equalization operation and an associated second decoding operation based on the equalization operation.

19. The method of claim 11, further comprising:
transmitting, using a first pre-equalization, data to the wireless device via the set of slots; and
transmitting, using the first pre-equalization, the pre-equalized DMRS based on the allocation of the resources.

20. A computer-readable medium storing computer executable code at a user equipment (UE), the code when executed by a processor causes the processor to:
receive, from a wireless device associated with the UE, a first indication of a capability to perform an equalization operation; and
transmit, to the wireless device, a second indication of an allocation of resources associated with a pre-equalized demodulation reference signal (DMRS) for the equalization operation, wherein the allocation of the resources is for less than all slots within a set of slots associated with a same pre-equalization.
